(19) United States
(12) Patent Application Publication
(10) Pub. No.: US 2016/0332422 A1
(43) Pub. Date: Nov. 17, 2016

(54) TRANSPARENT FILM, MANUFACTURING METHOD THEREFOR, TRANSPARENT CONDUCTIVE FILM, TOUCH PANEL, ANTI-REFLECTION FILM, POLARIZATION PLATE, AND DISPLAY DEVICE

(71) Applicant: FUJIFILM Corporation, Tokyo (JP)

(72) Inventors: Kiyokazu HASHIMOTO, Fujinomiya-shi (JP); Kenichi YAMAMOTO, Fujinomiya-shi (JP); Ayana FUJIMAKI, Fujinomiya-shi (JP)

(73) Assignee: FUJIFILM Corporation, Tokyo (JP)

(21) Appl. No.: 15/221,668

(22) Filed: Jul. 28, 2016

Related U.S. Application Data
(63) Continuation of application No. PCT/JP2015/052498, filed on Jan. 29, 2015.

(30) Foreign Application Priority Data
Jan. 31, 2014 (JP) 2014-016799

(51) Int. Cl. B32B 15/02; G06F 3/044; G02B 5/30; B29C 39/14; G02B 1/116

(52) U.S. Cl. CPC B32B 15/02; B29C 39/14; G02B 1/116; G02B 5/3083; G06F 3/044; B32B 2307/202; B32B 2307/42; B32B 2457/208; G06F 2203/04103; G06F 2203/04112

(57) ABSTRACT

An object of the invention is to provide a transparent film of which dimension shrinkage is suppressed even if a long period of time has passed at high humidity, a manufacturing method therefore, a transparent conductive film, a touch panel, an anti-reflection film, a polarization plate, and a display device. The invention provides a transparent film that satisfies Expressions (1) and (2), in which Rth that represents birefringence normalized in a thickness of 100 μm in a thickness direction is 1 nm to 50 nm, and inplane distribution of the Rth is 1% to 50%; Expression (1): 130≦T≦200; Expression (2): 0≦Y<0.4; in Expressions (1) and (2), T represents a glass transition temperature of the transparent film, and Y represents an equilibrium moisture content of the transparent film at 25° C.; and a unit of the glass transition temperature is ° C., and a unit of the equilibrium moisture content is mass %.

The present application is a continuation of PCT/JP2015/52498 filed on Jan. 29, 2015 and claims priority under 35 U.S.C. §119 of Japanese Patent Application Nos. 16799/2014 filed on Jan. 31, 2014.

### BACKGROUND OF THE INVENTION

1. Field of the Invention

The present invention relates to a transparent film and a manufacturing method therefor, a transparent conductive film, a touch panel, an anti-reflection film, a polarization plate, and a display device.

2. Description of the Related Art

Recently, uses of a liquid crystal display device, an organic electroluminescence display device (organic EL display device), a touch panel, or the like are widened. In this device, various resin films are used for a support, a protective film, or the like. Among these, the film formed from the cyclic olefin copolymer has high heat resistance, low water absorption, and excellent dimensional stability, and thus the film is preferably used.

As the cyclic olefin copolymer, JP2011-43628A discloses a film that consists of a cyclic olefin addition (co)polymer of which a copolymerization ratio of norbornene and ethylene is 80:20 to 90:10, a melt volume rate (MVR) is 0.8 cm³/10 min to 2.0 cm³/10 min, and a glass transition temperature (hereinafter, also referred to as “Tg”) is 170° C. to 200° C. and that has retardation of 100 nm to 150 nm.

WO07/122932A discloses a norbornene compound addition polymer film in which a rate of the dimensional change before heating and after cooling when the norbornene compound addition polymer film is heated from 25° C. to 200° C. and then cooled to 25° C. is 100 ppm or less, or a rate of the dimensional change before and after the norbornene compound addition polymer film is immersed in propylene glycol monomethyl ether acetate for one hour at 25° C. is 100 ppm or less.

JP2009-104152A discloses a phase difference film that contains inorganic particles which exhibit shape anisotropy and that have birefringence properties in which a refractive index in a long diameter direction is smaller than an average refractive index in a direction orthogonal to the long diameter direction; and a binder for fixing the inorganic particles, in which the inorganic particles are arranged in a predetermined condition.

JP2009-29108A discloses a laminate film obtained by laminating a cyclic olefin-based polymer layer, an anchor coat layer having polysiloxane containing metallic oxide fine particles in a dispersed manner, and a transparent conductive layer in this order.

JP2004-122433A discloses a film having a layer consisting of a polymer resin containing an alicyclic structure in which a melt index measured at the Tg of 130° C. or greater, at 280° C., and in the load condition of 2.16 kg is 50 g/10 minutes or less, in which the number of foreign substances of 0.1 mm or greater is 100 substances/m² or less, and heat shrinkage when a treatment is performed at 160° C. for one hour is 2% or less.

### SUMMARY OF THE INVENTION

A film used for the purpose of a touch panel or the like is required to have an excellent rate of the dimensional change even if a long period of time has passed not only at high temperature but also at high humidity.

JP2011-43628A discloses that a dimensional change can be suppressed in a heat treatment at 160° C. for 30 minutes, WO07/122932A discloses improvement of a dimensional change in a heat treatment at 200° C., JP2009-104152A discloses a change in physical properties (phase difference) at 40° C. 95% Rh and 80° C. is reduced, JP2009-29108A discloses a moisture permeability change at 40° C. 90% Rh and transparent conductive film characteristics (resistivity change) can be reduced at 85° C. 85% Rh, and JP2004-122433A discloses that a thermal dimensional change can be suppressed. As described above, in JP2011-43628A, WO07/122932A, JP2009-104152A, JP2009-29108A, and JP2004-122433A, changes in physical properties in a treatment at low humidity and high temperature are mainly examined, but changes in physical properties in a high humidity treatment are not sufficiently examined.

The invention has been conceived in order to solve the problems above, and an object thereof is to provide a transparent film in which dimension shrinkage is suppressed even if a long period of time has passed at high humidity. Another object of the invention is to provide a transparent conductive film using the transparent film of the invention, a manufacturing method for the transparent film of the invention, and a touch panel and a display device using the transparent film of the invention.

As a result of thoroughly conducting research in order to solve the problems described above, in a case where Rth that represents birefringence of the transparent film in the thickness direction, inplane distribution of the Rth, a glass transition temperature of the transparent film, and an equilibrium moisture content at 25° C. satisfy the predetermined conditions, the inventors found that the dimension shrinkage of the transparent film is suppressed even if a long period of time has passed at high humidity, so as to complete the invention.

Specifically, the invention has following configurations.

<1> A transparent film that satisfies Expressions (1) and (2), in which Rth that represents birefringence normalized in a thickness of 100 μm in a thickness direction is 1 nm to 50 nm,

in which inplane distribution of the Rth is 1% to 50%,

130≦T≦200 Expression (1):

0≦Y<0.4 Expression (2):

in which, in Expressions (1) and (2), T represents a glass transition temperature of the transparent film, and Y represents an equilibrium moisture content of the transparent film at 25° C., and a unit of the glass transition temperature is ° C., and a unit of the equilibrium moisture content is mass %.

<2> The transparent film according to <1>, in which distribution of dimension shrinkage of the transparent film at 125° C. 40% Rh is 0.01% to 0.3%.

<3> The transparent film according to <1> or <2>, in which the inplane distribution of the number of times of folding endurance is 3% to 30%.

<4> The transparent film according to any one of <1> to <3>, in which the transparent film is manufactured by casting a resin on a casting drum by a die such that a ratio of a discharge speed Vd of a resin in a die outlet and a speed Vc of a casting drum becomes 2 to 30, and in which the ratio represents Vc/Vd.

<5> The transparent film according to any one of <1> to <4> that is manufactured by providing a fluctuation of 1% to 30% in a width direction at a lip gap which is an interval of a die lip of a die outlet.

<6> The transparent film according to any one of <1> to <5> that is manufactured by providing a discharge fluctuation which is a time fluctuation to an amount of a resin supplied to the die by 0.1% to 10%.

<7> The transparent film according to any one of <1> to <6> that is manufactured by providing a temperature difference of 0.1° C. to 10° C. on front and back surfaces of the film during cooling from a point lower than the glass transition temperature by 20° C. to a point lower than the glass transition temperature by 40° C. in cooling the film after the film forming to room temperature.

<8> The transparent film according to any one of <1> to <7> that is manufactured by providing a fluctuation of 0.1% to 5% to transport tension of the film during cooling from a point lower than the glass transition temperature by 20° C. to a point lower than the glass transition temperature by 40° C. in a step of cooling the film after the film forming to room temperature.

<9> The transparent film according to any one of <1> to <8> that is manufactured by providing a step of 0.1 mm to 5 mm in a die in a step of forming the film by discharging a resin from the die.

<10> The transparent film according to any one of <1> to <9> that is manufactured by providing a temperature difference of 0.5° C. to 20° C. in a die in a step of forming the film by discharging a resin from the die.

<11> The transparent film according to any one of <4> to <10> that is manufactured by further stretching a film manufactured by performing casting, in a stretching ratio of 1.1 times to 5 times in at least one axis direction.

<12> A manufacturing method for the transparent film according to any one of <1> to <11>, comprising: casting a resin to a casting drum by a die, such that a ratio of a discharge speed Vd of the resin in a die outlet and a speed Vc of the casting drum becomes 2 to 30, in which the ratio represents Vc/Vd.

<13> The manufacturing method according to <12>, further comprising: providing a fluctuation of 1% to 30% in a width direction at a lip gap which is an interval of a die lip of a die outlet.

<14> The manufacturing method according to <12> or <13>, further comprising: providing a discharge fluctuation which is a time fluctuation to an amount of a resin supplied to the die by 0.1% to 10%.

<15> The manufacturing method according to any one of <12> to <14>, further comprising: providing a temperature difference of 0.1° C. to 10° C. on front and back surfaces of the film during cooling from a point lower than the glass transition temperature by 20° C. to a point lower than the glass transition temperature by 40° C. in cooling the film after the film forming to room temperature.

<16> The manufacturing method according to any one of <12> to <15>, further comprising: providing a fluctuation of 0.1% to 5% to transport tension of the film during cooling from a point lower than the glass transition temperature by 20° C. to a point lower than the glass transition temperature by 40° C. in cooling the film after the film forming to room temperature.

<17> The manufacturing method according to any one of <12> to <16>, further comprising: providing a step of 0.1 mm to 5 mm in a die in forming the film by discharging a resin from the die.

<18> The manufacturing method according to any one of <12> to <17>, further comprising: providing a temperature difference of 0.5° C. to 20° C. in a die in forming the film by discharging a resin from the die.

<19> The manufacturing method according to any one of <12> to <18>, further comprising: stretching a film manufactured by performing casting, in a stretching ratio of 1.1 times to 5 times in at least one axis direction.

<20> A transparent conductive film, comprising: the transparent film according to any one of <1> to <11>; and a conductive layer.

<21> The transparent conductive film according to <20>, in which the conductive layer is formed with a thin wire having a width of 0.1 μm to 50 μm.

<22> The transparent conductive film according to <21>, in which the thin wire includes Ag.

<23> The transparent conductive film according to <22>, in which the thin wire including Ag is formed by developing silver halide.

<24> A touch panel having the transparent film according to any one of <1> to <11> and the transparent conductive film according to any one of <20> to <23>.

<25> An anti-reflection film having the transparent film according to any one of <1> to <11>.

<26> A polarization plate having the transparent film according to any one of <1> to <11>.

<27> A display device having the transparent film according to any one of <1> to <11> or the polarization plate according to <26>.

According to the invention, it is possible to provide a transparent film in which dimension shrinkage can be suppressed even if a long period of time has passed at high humidity. According to the invention, it is possible to provide a manufacturing method for the transparent film, and a transparent conductive film, a touch panel, and a display device using the transparent film.

### DESCRIPTION OF THE PREFERRED EMBODIMENTS

Hereinafter, the invention is described in detail. Explanations of components described below are provided with reference to representative embodiments and specific examples, but the invention is not limited to the embodiments. The numerical range described by using the expression “to” means a range including numerical values described before and after the expression “to”, as upper and lower limits.

A “vertical direction” in this specification refers to a direction (MD direction) of casting a belt-type (long) film, and a “horizontal direction (referred to as the width direction)” refers to a direction (TD direction) orthogonal to the direction (MD direction) of casting the belt-type (long) film.

(Transparent Film)

The transparent film of the invention satisfies Expressions (1) and (2) below and is characterized in that Rth that represents birefringence normalized in the thickness of 100 in the thickness direction is 1 nm to 50 nm, and inplane distribution of the Rth is 1% to 50%.

130≦T≦200 Expression (1):

0≦Y<0.4 Expression (2):

In Expressions (1) and (2), T represents the glass transition temperature of a transparent film, and Y represents an equilibrium moisture content of the transparent film at 25° C.; and a unit of the glass transition temperature is ° C., and a unit of an equilibrium moisture content is mass %.

A material having low moisture contents (for example, a film including cyclic olefin) basically has characteristics in that changes at temperature and moisture are difficult. The present inventors have found that a film is deteriorated if the film is left for a long period of time at high humidity even if the film is a film consisting of a material having low moisture contents, dimension shrinkage occurs accordingly, fractures are generated in the conductive layer or the hard coat layer due to the difference in dimensional changes from a hard layer such as a conductive layer or a hard coat layer installed on the film, and thus performance is decreased. For example, in a case where the conductive layer is provided on the film, cracks are generated in the conductive layer due to the difference in stretch between the film and the conductive layer, and thus conductivity is decreased. In a case where the hard coat layer is provided on the film, if a dimensional change is generated on the film, a solid hard coat layer does not follow the dimensional change, and thus cracks are generated. In a case where the transparent film of the invention is used, dimension shrinkage is suppressed even in a case where the transparent film is left for a long period of time at high humidity, and thus the problems above can be removed.

According to the invention, the film is formed so as to satisfy Expressions (1) and (2) above, cause Rth that represents birefringence normalized in the thickness of 100 μm in the thickness direction to be 1 nm to 50 nm, and cause inplane distribution of the Rth to be 1% to 50%, a dimension shrinkage rate is suppressed even if a long period of time has passed at high humidity. It is considered that this mechanism is as follows.

It is assumed that if Rth is greater than the range according to the invention, orientation (phenomenon of laminating a layer to be oriented in parallel on the film surface) of the polymer in the film in the surface direction is strong, and, if this orientation is exposed to high temperature and high humidity, the film is shrunk to be original random molecular sequence, such that the dimension shrinkage is generated, and a dimensional change occurs.

Meanwhile, it is assumed that, if Rth is less than the range of the invention, plane orientation is too loose, gaps between particles are many, water molecules are introduced thereto, expansion (dimensional stretch) is generated, and thus a dimensional change increases.

<Physical Properties of Transparent Film>

The transparent film of the invention preferably satisfies Expression (1) below and Expression (1-1) below and more preferably satisfies Expression (1-2) below. T represents the glass transition temperature (° C.) of the transparent film.

130≦T≦200 Expression (1):

140≦T≦185 Expression (1-1):

145≦T≦170 Expression (1-2):

If the glass transition temperature is less than 130° C., a thermal expansion coefficient in an area which is greater than the glass transition temperature is great, stretching is not completely returned even if the temperature is returned to the low temperature, and stretching remains. That is, dimension shrinkage increases. Meanwhile, if the glass transition temperature is greater than 200° C., thermal expansion hardly increases. However, mobility of the molecule decreases, the dehumidification does not return to the original (structure at high temperature is fixed as it is), stretching remains, and dimension shrinkage easily increases.

The glass transition temperature T is measured at a temperature elevation speed of 10° C./minutes by using 2920-type DSC manufactured by TA Instruments.

The transparent film of the invention preferably satisfies Expression (2) below and Expression (2-1) below and more preferably satisfies Expression (2-2) below (Y represents equilibrium moisture content (%) of the transparent film at 25° C.).

0≦Y<0.4 Expression(2):

0≦Y<0.4 Expression (2-1):

0≦Y≦0.3 Expression (2-2):

If the equilibrium moisture content is greater than 0.4, the film absorbs water and the dimension stretches at high humidity. Even if the film is put at low moisture such that the moisture is removed, the dimension does not return to the original, and the stretching remains (dimensional change increases (hysteresis)).

The equilibrium moisture content at 25° C. can be measured by immersing the sample film in pure water at 25° C. for one night, removing the sample film therefrom, quickly removing the moisture on the front surface, and performing moisture measurement at a vaporization temperature of 120° C. by using a Karl Fischer moisture meter (manufactured by Kyoto Electronics Manufacturing Co., Ltd., MKC-520).

The dimension shrinkage in a case being put at high temperature and high humidity for a long period of time can be further suppressed by causing the glass transition temperature of the transparent film and the equilibrium moisture content at 25° C. to be in the range described above.

In view of the effect of the invention, the transparent film of the invention preferably further satisfies Expression (3) below, more preferably satisfies Expression (3-1) below, and even more preferably Expression (3-2) below.

0≦Y≦0.0146×T−1.8 Expression (3):

0≦Y≦0.02×T−2.7 Expression (3-1):

Y≧0.005×T−0.85 Expression (3-2):

In the transparent film of the invention, Rth that represents birefringence normalized in the thickness of 100 μm in the thickness direction is 1 nm to 50 nm, preferably 3 nm to 40 nm, and more preferably 5 nm to 35 nm.

If Rth is greater than 50 nm, the orientation (plane orientation) of the cyclic olefin molecule in the film surface direction is strong, the orientation shrinks to be random at high temperature and high humidity, the dimension shrinkage is generated, and the dimensional change increases. Meanwhile, if Rth is less than 1 nm, the plane orientation becomes too loose, gaps between molecules are many, water molecules are introduced thereto, expansion (dimensional stretch) is easily generated, and thus a dimensional change increases.

If Rth is caused to be 1 nm to 50 nm, dimensional changes at high temperature and high humidity can be further suppressed.

In this specification, birefringence (retardation in the thickness direction) Rth in the thickness direction is a parameter indicating an average of the retardation obtained by respectively applying film thickness d to two items of birefringence Δnac (=|na−nc|) and Δnbc (=|nb−nc|) when the film is seen from the cross section in the film thickness direction.

The retardation (Rth) in the thickness direction is indicated by Expression (A) below.

Rth={(na+nb)/2−nc}×d (A)

In Expression (A) above, na is a refractive index of the transparent film in the in-plane slow axis direction, nb is a refractive index of the transparent film in the in-phase fast axis direction (direction orthogonal to the in-plane slow axis direction), nc is a refractive index of the transparent film in the thickness direction, and d is the thickness of the transparent film.

Rth obtained in this manner is normalized at 100 μm as below, and Rth that represents the birefringence normalized in the thickness of 100 μm in the thickness direction can be obtained.

Rth normalized 100 μm=(Rth actually measured)/(thickness(μm)/100)

In The transparent film of the invention, the inplane distribution of Rth is 1% to 50%, preferably 2% to 40%, and even more preferably 3% to 30%. If the inplane distribution of Rth is in the range above, “dimension shrinkage” in an area having great Rth and “dimension stretch” in an area having small Rth are offset, such that dimensional change in the entire film can be suppressed.

If the inplane distribution of Rth is less than 1%, the effect above cannot be obtained, a dimensional change increases. Meanwhile, if the inplane distribution is greater than 50%, the effect of the dimension shrinkage in the area having great Rth is actualized, and the dimensional change easily increase.

The Rth inplane distribution is obtained from the expression below by measuring Rth in the method above in ten points arbitrarily selected from the sample film of 30 cm×20 cm.

Rth inplane distribution (%)=100×(maximum value−minimum value)/average value

In the transparent film of the invention, the distribution of the dimension shrinkage in an acceleration test at 125° C. 40% Rh is preferably 0.005% to 0.5%, more preferably 0.008% to 0.4%, and even more preferably 0.01% to 0.3%. Rh represents relative humidity. If the distribution of the dimension shrinkage at 125° C. 40% Rh in the range above, the dimension shrinkage can be suppressed at high humidity for a long period of time high humidity.

If the distribution of the dimension shrinkage in the acceleration test at 125° C. 40% Rh is greater than 0.5%, fractures are generated in the conductive layer, the hard coat layer, or the like due to the dimensional change difference from the conductive layer. If the distribution of the dimension shrinkage is less than 0.005%, fractures are generated in the conductive layer, the hard coat layer, and the like. This is because these layers are also dimensionally changed, and if the film is not dimensionally changed, fractures are generated due to this dimension difference.

The acceleration test is to reproduce phenomena (dimensional changes or the like) during several years in normal temperature in just about ten minutes by exposing the film at high temperature and high humidity in order to perform evaluations in an optimized manner by reducing several years required for exhibiting influence of the high humidity in normal temperature. This acceleration test is achieved by exposing a sample in a thermostatic bath with no load at high temperature and high humidity (125° C. 40% Rh). This high temperature and high humidity condition can be achieved by introducing saturated steam at 125° C. to an air thermostatic bath and adjusting the amount thereof.

In the transparent film of the invention, the dimension shrinkage at 125° C. 40% Rh is preferably distributed. Specifically, the distribution of the dimension shrinkage at 125° C. 40% Rh is preferably 0.01% to 0.3%, more preferably 0.03% to 0.25%, and even more preferably 0.05% to 0.2%. Accordingly, in a case where the average dimension shrinkage is the same, the fractures of the conductive layer of the upper layer can be suppressed. It is assumed that this is because, if the distribution of the dimension shrinkage exists, portions having small and large dimension shrinkage coexist, a portions having small dimension shrinkage suppresses the dimension shrinkage of the entire film, and thus the fractures of the conductive layer can be suppressed.

If the dimension shrinkage above is less than 0.01%, the effect above cannot be obtained, and the fractures of the conductive layer cannot be prevented. Meanwhile, if the dimension shrinkage above is greater than 0.3%, a portion having great in-plane shrinkage is generated, and fractures of the conductive layer are generated therefrom.

The dimension shrinkage (the rate of the dimensional change) can be obtained by being measured by the following method.

Ten points are respectively sampled in the vertical direction (MD) and the horizontal direction (TD), the difference between the maximum value and the minimum value of the dimension shrinkage rates is obtained in each of MD and TD, and the distribution of the dimension shrinkage represents a greater value among the values in MD and TD.

In the transparent film of the invention, the number of times of folding endurance is preferably 50 times or greater, more preferably 80 times to 2,000 times, and even more preferably 100 times to 1,000 times. If the number of times of folding endurance is caused to be in this range, breaks hardly occur in the film even if the film is put at high humidity for a long period of time. That is, due to deformation caused by the difference from the thermal expansion rate of the hard layer (the conductive layer or the hard coat layer) provided on the film, it is possible to suppress the generation of cracks on the film or breakage of the film. This is particularly effective when the film is used in a folded manner.

If the number of times of folding endurance is less than 50 times, cracks or breaks are easily generated in the film at high humidity when a long period of time has passed, such that electric resistance may increase after the thermo treatment (after a long period of time has passed at high humidity). Meanwhile, if the strength of folding endurance is too great, foreign substances are easily generated while the film is formed.

The number of times of folding endurance can be obtained by performing a folding test with a MIT tester according to JIS P8115.

In the transparent film of the invention, inplane distribution of the number of times of folding endurance is preferably 3% to 30%, more preferably 5% to 25%, and even more preferably 7% to 20%. If the inplane distribution of the number of times of folding endurance is caused to be in this range, shredded waste is hardly generated even if the film is folded. The shredded waste is waste peeled off from the transverse section of the film when the film is shredded. If this is attached to the front surface of the film and further coating is performed thereon, the surface defects or the defective adhesion is easily generated (particularly, cyclic olefin has less a polar group, has weak interaction between molecules, and easily peeled off).

If inplane distribution exists in the strength of folding endurance, the strength of the entire film increases by the portions having strong strength of folding endurance. In a case of having the same average number of times of folding endurance, the shredded waste is hardly peeled off than the film having small distribution, and the generation of the shredded waste is suppressed.

Accordingly, if the inplane distribution of the number of times of folding endurance is less than 3%, the shredded waste may increase. However, if the inplane distribution is greater than 30%, in a portion having low strength of folding endurance, the film is brittle and the shredded waste is easily discharged. Therefore, the shredded waste increases.

The “folding endurance” is destruction (break) of the film, which is generated when the film is folded. If a film defect to be the beginning exists, the film breaks from the film defect as the start, and thus the number of times of folding endurance easily decreases. According to the invention, as described below, unevenness (defect) is formed by giving a fluctuation to an entanglement amount of the molecules in the die or giving a speed fluctuation during stretching, and distribution is provided to the number of times of folding endurance.

Difference between the maximum value and the minimum value when ten arbitrary points along MD are sampled and the strength of folding endurance is measured is divided by an average of the ten points and indicated by percentage so as to obtain a value (MD distribution), and measurement in the same manner is performed in TD, so as to obtain TD distribution. The inplane distribution of the number of times of folding endurance refers to an average value of the obtained MD distribution and the obtained TD distribution.

The transparent film of the invention refers to a film having the total light transmittance of 80% or greater. The total light transmittance is more preferably 84% or greater and even more preferably 88% or greater.

The thickness of the transparent film of the invention is preferably 10 μm to 100 μm, more preferably 15 μm to 80 μm, and even more preferably 20 μm to 70 μm. The thickness herein represents the thickness after the film is formed in a case where the film is used without stretching (unstretching) and the thickness after the film is stretched in a case where the film is stretched to be used.

<Raw Material of Transparent Film>

With respect to the transparent film of the invention, the raw material of the transparent film is not particularly limited, as long as Expressions (1) and (2) above are satisfied, Rth that represents the birefringence normalized in the thickness of 100 μm in the thickness direction is 1 nm to 50 nm, and the inplane distribution of Rth is 1% to 50%. Examples of the raw material of the transparent film when Expressions (1) and (2) are satisfied include a cyclic olefin-based resin, polycarbonate (PC), polysulfone (PSF), polyetherimide (PEI), and polyarylate (PAr). Among these, since polycarbonate (PC) and a cyclic olefin-based resin can easily achieve Rth above and advantageous in cost, and a cyclic olefin-based resin is even more preferable.

T and Y of the resin exemplified above are as presented in Table 1.

TABLE 1

| | T (° C.) | Y (%) |
|---|---|---|
| Cyclic olefin-based resin | 120 to 180 | 0.01 to 0.4 |
| Polycarbonate (PC) | 140 | 0.2 |
| Polysulfone (PSF) | 180 | 0.03 |
| Polyetherimide (PEI) | 200 | 0.25 |
| Polyarylate (PAr) | 190 | 0.2 |

<Cyclic Olefin-Based Resin>

Preferable examples of the norbornene resin (norbornene unit) made of the raw material of the cyclic olefin-based resin include a saturated norbornene resin-A and a saturated norbornene resin-B described below. All of these saturated norbornene resins can be formed to films by a solution film forming method and a melting film forming method described below. However, the saturated norbornene resin-A is more preferably formed to a film by the melting film forming method, and the saturated norbornene resin-B is more preferably formed to a film by the solution film forming method.

[Saturated Norbornene Resin-A]

Examples of the saturated norbornene resin-A include (1) a resin obtainable by hydrogenating a ring-opened (co)polymer of a norbornene-based monomer after performing polymer modification such as maleic acid addition and cyclopentadiene addition, if necessary, (2) a resin obtainable by performing addition polymerization to the norbornene-based monomer, and (3) a resin obtainable by performing addition copolymerization on a norbornene-based monomer and an olefin-based monomer such as ethylene or α-olefin. A polymerization method and a hydrogenation method can be performed in normal methods.

Examples of the norbornene-based monomer include norbornene, alkyl and/or alkylidene substitution products thereof (for example, 5-methyl-2-norbornene, 5-dimethyl-2-norbornene, 5-ethyl-2-norbornene, 5-butyl-2-norbornene, and 5-ethylidene-2-norbornene), and polar group substitution products of these halogen or the like; dicyclopentadiene, and 2,3-dihydrodicyclopentadiene; dimethanooctahydronaphthalene, alkyl and/or alkylidene substitution products thereof, and polar group substitution products of halogen or the like (for example, 6-methyl-1,4:5,8-dimethano-1,4,4a,5,6,7,8,8a-octahydronaphthalene, 6-ethyl-1,4:5,8-dimethano-1,4,4a,5,6,7,8,8a-octahydronaphthalene, 6-ethylidene-1,4:5,8-dimethano-1,4,4a,5,6,7,8,8a-octahydronaphthalene, 6-chloro-1,4:5,8-dimethano-1,4,4a,5,6,7,8,8a-octahydronaphthalene, 6-cyano-1,4:5,8-dimethano-1,4,4a,5,6,7,8,8a-octahydronaphthalene, 6-pyridyl-1,4:5,8-dimethano-1,4,4a,5,6,7,8,8a-octahydronaphthalene, and 6-methoxycarbonyl-1,4:5,8-dimethano-1,4,4a,5,6,7,8,8a-octahydronaphthalene); an adduct of cyclopentadiene and tetrahydroindene; and trimers or tetramers of cyclopentadiene (for example, 4,9:5,8-dimethano-3a,4,4a,5,8,8a,9,9a-octahydro-1H-benzoindene, and 4,11:5,10:6,9-trimethano-3a,4,4a,5,5a,6,9,9a,10,10a,11,11a-dodecahydro-1H-cyclopentanthracene). These norbornene-based monomers may be used singly or two or more types thereof may be used in combination.

[Saturated Norbornene Resin-B]

Examples of the saturated norbornene resin-B include compounds expressed by General Formulae (1) to (4) below. Among these, compounds expressed by General Formula (1) below are particularly preferably.

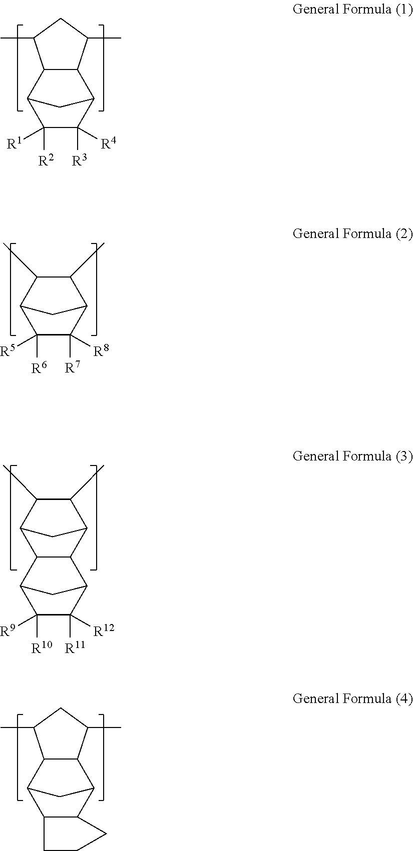

In General Formulae (1) to (4), each of R¹ to R¹² independently represents a hydrogen atom or a univalent substituent (preferably an organic group), and at least one of these is preferably a polar group. In general, a mass average molecule amount of these saturated norbornene resins is preferably 5,000 to 1,000,000 and more preferably 8,000 to 200,000.

Examples of the substituent above are substituents disclosed in paragraph “0036” of JP5009512B. Examples of the polar group above include polar groups disclosed in paragraph “0037” of JP5009512B.

Examples of the saturated norbornene resin that can be used in the invention include resins disclosed in JP1985-168708A (JP-S60-168708A), JP1987-252406A (JP-S62-252406A), JP1987-252407A (JP-S62-252407A), JP1990-133413A (JP-H02-133413A), JP1988-145324A (JP-S63-145324A), JP1988-264626A (JP-S63-264626A), JP1989-240517A (JP-H01-240517A), and JP1982-8815B (JP-S57-8815B).

Among these, a hydrogenated polymer obtained by hydrogenating a ring-opened polymer of a norbornene-based monomer is particularly preferable.

According to the invention, as the saturated norbornene resin, at least one type of the tetracyclododecene derivatives expressed by General Formula (5) below, or a hydrogenated polymer obtainable by hydrogenating a polymer obtainable by performing metathesis polymerization on the tetracyclododecene derivative above and an unsaturated cyclic compound copolymerizable with this tetracyclododecene derivative.

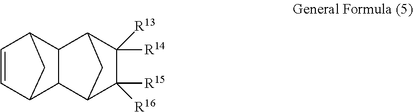

In General Formula (5), each of R¹³ to R¹⁶ independently represents a hydrogen atom or a univalent substituent (preferably an organic group), and at least one of these is preferably a polar group. Specific examples and preferable ranges of the substituent and the polar group described herein are the same as described with respect to General Formulae (1) to (4).

With respect to the tetracyclododecene derivative expressed by General Formula (5) above, if at least one of R¹³ to R¹⁶ is a polar group, a polarizing film having excellent adhesiveness to other materials, excellent heat resistance, or the like can be obtained. It is preferable that this polar group is a group expressed by —(CH₂)ₙCOOR (here, R represents a hydrocarbon group having 1 to 20 carbon atoms, and n represents an integer of 0 to 10.), since a finally obtainable hydrogenated polymer (substrate of polarizing film) has a high glass transition temperature. Particularly, it is preferable that one of this polar substituent expressed by —(CH₂)ₙCOOR is contained in each one molecule of a tetracyclododecene derivative of General Formula (5), since water absorption is decreased. In the polar substituent above, as the number of carbon atoms of the hydrocarbon group expressed by R increases, it is more preferable since hygroscopic properties of the obtainable hydrogenated polymer are small. However, in view of the balance with the glass transition temperature of the obtainable hydrogenated polymer, the hydrocarbon group above is preferably a chain alkyl group having 1 to 4 carbon atoms or a (poly)cyclic alkyl group having 5 or greater carbon atoms, and particularly preferably a methyl group, an ethyl group, and a cyclohexyl group.

A tetracyclododecene derivative of General Formula (5) in which, as a substituent, a hydrocarbon group having 1 to 10 carbon atoms is bonded to a carbon atom to which a group expressed by —(CH₂)ₙCOOR is bonded is preferable, since hygroscopic properties of the obtainable hydrogenated polymer are low. Particularly, the tetracyclododecene derivative of General Formula (5) in which the substituent is a methyl group or an ethyl group is preferable since the synthesization thereof is easy. Specifically, 8-methyl-8-methoxycarbonyltetracyclo [4,4,0,1^{2.5},1^{7.10}]dodeca-3-ene is preferably. Mixtures of these tetracyclododecene derivatives and unsaturated cyclic compounds copolymerizable with the tetracyclododecene derivatives can be subjected to metathesis polymerization and hydrogenation, for example, by methods disclosed in line 12 on the upper right column of page 4 to line 6 on the lower right column of page 6 of JP1992-77520A (JP-H04-77520A).

With respect to these norbornene-based resins, the intrinsic viscosity (ηᵢₙₕ) measured at 30° C. in chloroform is preferably 0.1 dl/g to 1.5 dl/g and even more preferably 0.4 dl/g to 1.2 dl/g. With respect to the hydrogenation rate of the hydrogenated polymer, the value measured with ¹H-NMR at 60 MHz is preferably 50% or greater, more preferably 90% or greater, and even more preferably 98% or greater. As the hydrogenation rate is higher, the obtainable saturated norbornene film has excellent stability to heat or light. A gel content included in the hydrogenated polymer is preferably 5 mass % or less and even more preferably 1 mass % or less.

[Other Ring-Opened Polymerizable Cycloolefins]

According to the invention, other ring-opened polymerizable cycloolefins can be used together. Specific examples of this cycloolefin include a compound having one reactive double bond such as cyclopentene, cyclooctene, or 5,6-dihydrodicyclopentadiene. The content of these ring-opened polymerizable cycloolefins is preferably 0 mol % to 50 mol %, more preferably 0.1 mol % to 30 mol %, and particularly preferably 0.3 mol % to 10 mol % with respect to the norbornene-based monomer above.

The cyclic olefin-based resin may be a cyclic olefin copolymer including an ethylene unit and a norbornene unit. The ethylene unit is a repeating unit expressed by —CH₂CH₂—. If the ethylene unit is subjected to vinyl polymerization with the norbornene unit described above, a cyclic olefin copolymer can be obtained. The copolymerization molar ratio of the norbornene unit and the ethylene unit is preferably 80:20 to 20:80, more preferably 80:20 to 50:50, and even more preferably 80:20 to 60:40.

The cyclic olefin copolymer may contain a small amount of the repeating unit consisting of other copolymerizable vinyl monomers other than the ethylene unit and the norbornene unit. Specific examples of the other vinyl monomer include α-olefin having 3 to 18 carbon atoms such as propylene, 1-butene, 1-hexene, 4-methyl-1-pentene, 1-octene, 1-decene, 1-dodecene, 1-tetradecene, 1-hexadecene, and 1-octadecene, and cycloolefin such as cyclobutene, cyclopentene, cyclohexene, 3-methylcyclohexene, and cyclooctene. These vinyl monomers may be used singly or two or more types thereof may be used in combination. The content of the repeating unit is preferably 10 mol % or less and more preferably 5 mol % or less with respect to the entire content.

[Other Additives]

Other additives may be added to the cyclic olefin-based resin without deteriorating the object of the invention. Examples of the additives include an antioxidant, an ultraviolet absorbent, a lubricant, and an antistatic agent. Particularly, in a case where the cyclic olefin-based resin is provided on front surfaces of various devices, the cyclic olefin-based resin preferably includes an ultraviolet absorbent. As the ultraviolet absorbent, a benzophenone-based ultraviolet absorbent, a benzotriazole-based ultraviolet absorbent, an acrylonitrile-based ultraviolet absorbent, and the like can be used.

The cyclic olefin-based resin is divided into an addition polymerization type and a ring-opening polymerization type, and both of the polymerization types can be used. Examples of the ring-opening polymerization-type cyclic olefin-based resin include ring-opening polymerization-type cyclic olefin-based resins disclosed in WO2009/041377A, WO2008/108199A, WO2007/001020A, WO2006/112304A, JP2008-037932A, WO2007/043573A, WO2007/010830A, JP2007-525979 (JP5233280B), WO2007/001020A, JP2007-063356A, JP2009-210756A, JP2008-158088A, JP2001-356213A, JP2004-212848A, JP2003-014901A, JP2000-219752A, JP2005-008698A, WO2007/135887A, JP2012-056322A, JP1995-197623A (JP-H07-197623A), JP2006-215333A, JP2006-235085A, JP2005-173072A, JP2003-578978A (JP4292993B), JP2004-258188A, JP2003-136635A, JP2003-236915A, JP1998-130402A (JP-H10-130402A), JP1997-263627A (JP-H09-263627A), JP1992-361230A (JP-H04-361230A), JP1992-363312A (JP-H04-363312A), JP1992-170425A (JP-H04-170425A), and JP1991-223328A (JP-H03-223328A).

Examples of the addition polymerization-type cyclic olefin-based resin include addition polymerization-type cyclic olefin-based resins disclosed in WO2009/139293A, WO2006/030797A, JP2006-535159 (JP4493660B), JP2007-232874A, JP2007-009010A, WO2013/179781A, WO2012/114608A, WO2008/078812A, JP1999-142645A (JP-H11-142645A), JP1998-287713A (JP-H10-287713A), JP2008-548162 (JP5220616B), JP1999-142645A (JP-H11-142645A), JP1998-258025A (JP-H10-258025A), JP2001-026682A, JP1993-025337A (JP-H05-025337A), and JP1991-273043A (JP-H03-273043A).

(Manufacturing Method for Transparent Film)

The manufacturing method for the transparent film of the invention includes a step of casting the resin from the die to the casting drum, such that a ratio of a discharge speed of the resin at the die outlet and a speed of the casting drum above becomes 2 to 30 and a step of stretching the resin in at least one axis direction in the stretching ratio of 1.1 times to 5 times. If this method is employed, the dimension shrinkage is suppressed in the transparent film obtainable by the manufacturing method for the transparent film of the invention even if a long period of time has passed under high humidity.

The transparent film of the invention can be formed in all methods of the solution film forming method and the melting film forming method, but the melting film forming method is more preferable.

In the melting film forming method, before the film is formed, additives (an ultraviolet absorbent, a matting agent, a stabilizer, an antistatic agent, and the like) are added, if necessary, and the resin is dried. The preferable drying condition is 80° C. to Tg of the resin and more preferably 100° C. to Tg −5° C. The preferable drying time is 0.5 hours to 24 hours and more preferably 1 hour to 10 hours.

<Extrusion>

As types of extruders, a single screw extruder having relatively inexpensive equipment cost is used in many cases. Examples thereof include screw types such as a full flight type, a maddock type, and a dulmage type, but the full flight type is preferable. If a screw segment is changed, a twin screw extruder in which a ventilation opening is provided in the middle and extrusion can be performed while unnecessary volatile components are devolatilized can be used. The twin screw extruder is greatly classified into a same direction type and a different direction type, and the both types can be used. However, a same direction rotation type that hardly generates remaining portions and that has excellent cleaning performance is preferable.

<Filtration>

In order to filter foreign substances in the resin or to avoid damages in a gear pump caused by the foreign substances, it is preferable to perform so-called breaker plate-type filtration performed by providing a filter filtration medium at an outlet of the extruder. In order to highly accurately filter foreign substances, it is preferable to provide a filtration device in which a leaf-type disc filter is combined after the passage of the gear pump. The filtration can be performed by providing one filtration portion, or may be a multi-stage filtration performed by providing plural filtration portions. It is preferable that the filtration accuracy of the filter filtration medium is high. However, in view of pressure resistance of the filtration medium and filtration pressure increase due to clogging of the filtration medium, the filtration accuracy is preferably 15 μm to 3 μm and even more preferably 10 μm to 3 μm. In a case where a leaf-type disc filter device that finally performs foreign substance filtration is used, it is particularly preferable to use a filtration medium having high filtration accuracy, and it is possible to adjust the number of charged sheets in order to secure pressure resistance and aptitude of filter life. With respect to the types of the filtration medium, in view of the use at high temperature and high pressure, a steel material is preferably used. Among steel materials, stainless steel, steel, and the like are particularly preferably used. In view of corrosion, stainless steel is particularly desirably used. As the configuration of the filtration medium, in addition to weaving wire materials, a sintered filtration medium formed by sintering metal long fibers or metal powders can be used. In view of the filtration accuracy and the filter life, the sintered filtration medium is preferable.

<Gear Pump>

It is preferable that a gear pump is provided between the extruder and the dice, and a given amount of resin is supplied from the gear pump. The discharge fluctuation can be given by giving a fluctuation to the number of rotations. The gear pump containing a pair of gears consisting of a driving gear or a driven gear in a state of being engaged with each other, rotating both gears in an engaged manner by driving the driving gear so as to suck the resin in the melt state from a suction port formed in a housing into a cavity, and discharging a given amount of the resin from the discharging opening formed in the housing in the same manner.

<Die>

The resin is melt by the extruder formed as described above, and the melt resin is continuously sent to the die via a filtering machine and a gear pump, if necessary. As the die, all types of dies that are a T die, a fishtail die, and a hanger coat die that are generally used can be used. Immediately before the die, a static mixer for increasing evenness of the resin temperature can be interposed therebetween.

The temperature distribution of the die is preferably 0.5° C. to 20° C., more preferably 1° C. to 15° C., and even more preferably 2° C. to 10° C. If the die has the temperature distribution in the range described above, irregularity is provided to a mixing amount of the resin in the die, the inplane distribution of the number of times of folding endurance becomes 3% to 30%, and the shredded waste is hardly generated.

If the temperature distribution of the die is less than 0.5° C., the distribution of the number of times of folding endurance may become less than 3%. If the temperature distribution of the die is greater than 20° C., the distribution of the number of times of folding endurance may be greater than 30%.

The temperature distribution of the die may be given in either or both of the width direction or the longitudinal direction (melt flowing direction). The temperature distribution like this can be achieved by installing heaters splitted in the width direction and the longitudinal direction in the die and controlling temperatures thereof.

In the transparent film of the invention, the inplane distribution of Rth is required to be 1% to 50%, but the distribution of Rth can be adjusted by adjusting the fluctuation of the die lip or a stretching speed described below.

[Adjusting Distribution of Rth of Transparent Film in Width Direction]

If the interval (lip gap) of the resin outlets of the die lip distributed, the inplane distribution of Rth can be adjusted.

In a portion having a great lip gap, a discharge speed is great and Vc is great. In a portion having a small lip gap, a discharge speed is small and Vc is small. Meanwhile, since Vd is constant in the width direction, distribution is exhibited in Vc/Vd in the width direction, and Rth distribution is exhibited in the width direction.

Lip gaps are measured at points obtained by dividing the entire width of the die into 30 equal points, differences between the maximum values and the minimum values are divided by an average value of the 30 points, and the result is indicated by percentage, so as to obtain the distribution of the lip gap.

The distribution of the lip gap is preferably 1% to 30%, more preferably 2% to 25%, and even more preferably 3% to 20%. If the distribution of the lip gap is greater than 30%, the inplane distribution of Rth may be greater than 50%, and if the distribution of the lip gap is less than 1%, the inplane distribution of Rth may be less than 1%.

[Adjusting Distribution of Rth of Transparent Film in Longitudinal Direction]

It is possible to adjust the inplane distribution of Rth by providing a fluctuation to the discharging of the resin from the die lip, that is, by providing the fluctuation to the supplying amount of the resin to the die.

The fluctuation of the supplying amount of the resin to the die is preferably 0.1% to 10%, more preferably 0.3% to 8%, and even more preferably 0.5% to 7%. If the fluctuation of the supplying amount is greater than 10%, the inplane distribution of Rth may be greater than 50%, and if the fluctuation of the supplying amount is less than 0.1%, the inplane distribution of Rth is less than 1%.

Discharging amounts of the resin for one minute are measured ten times, differences between the maximum values and the minimum values are divided by an average value of the ten points, and the result is indicated by percentage, so as to obtain the supplying amount of the resin to the die.

It is possible to achieve high strength of folding endurance by producing a lot of interlocking of molecules in the resin. If the resin is mixed before casting, interlocking can be increased and the strength of folding endurance can be enhanced. The mixture is preferably performed immediately before the casting and preferably performed in the die.

In order to exhibit the mixture in the die, a step is provided to the die. That is, the mixture can be achieved by changing the height of the gap through which the resin passes to the longitudinal direction. It is considered that this is because the flow of the resin is shaken up in a step portion and the mixture is promoted.

The step is preferably 0.1 mm to 5 mm, more preferably 0.2 mm to 4 mm, and even more preferably 0.3 mm to 3 mm. If the step is less than 0.1 mm, the effect of the mixture is not sufficient, and the number of times of folding endurance becomes less than 50 times. If the step is greater than 5 mm, the resin stays at the portion of the step and the staying resin becomes an insoluble material, such that the foreign substances are easily generated.

<Casting>

In the method described above, the melt resin extruded to the sheet by the die is cooled and solidified on the casting drum, so as to obtain an unstretched film. At this point, it is preferable to increase the adhesion between the casting drum and the melt and extruded sheet by using the method of an electrostatic application method, an air knife method, an air chamber method, a vacuum nozzle method, a touch roller method, and the like. This adhesion increase method can be performed on the entire surface of the melt and extruded sheet or on a portion thereof. Particularly, a method of adhering only both ends of the film, so-called edge pinning, is performed in many cases, but the invention is not limited thereto.

It is more preferable to perform slow cooling on casting drums by using plural cooling rollers. In general, the slow cooling using three cooling rollers is relatively frequently performed, but the invention is not limited thereto. The diameter of the roller is preferably 50 mm to 5,000 mm, and the interval of the plural rollers is preferably 0.3 mm to 300 mm from surface to surface.

The casting drum is preferably Tg −70° C. to Tg +20° C. of the resin, more preferably Tg −50° C. to Tg +10° C., and even more preferably Tg −30° C. to Tg +5° C.

When the resin which is the raw material of the transparent film is extruded from the die and solidified on the casting drum, Rth is exhibited. Before the solidification, molecules that form the resin are random and non-oriented, and plane-oriented in the course of the solidification. In order to cause Rth that represents the birefringence normalized in the thickness of 100 μm in the thickness direction to be 1 nm to 50 nm, it is required to control the plane orientation. The control of the plane orientation can be performed by adjusting the ratio (Vc/Vd) of the discharge speed (Vd) of the resin at the die outlet and the speed (Vc) of the casting drum. If Vc is caused to be greater than Vd, the film extruded from the die is stretched, the plane orientation progresses while the thickness thereof is thinned, and Rth increases. If Vc is caused to be greater than Vd, the thickness distribution generated in the thickness of the casting film due to the distribution of the width of the opening can be reduced. The thickness distribution of the resin is extended and reduced by extending (stretching) the resin discharged from the die.

The ratio (Vc/Vd) of the discharge speed (Vd) of the resin at the die outlet and the speed (Vc) of the casting drum is preferably 2 to 30, more preferably 3 to 20, and even more preferably 4 to 15. If Vc/Vd is greater than 30, Rth may become greater than 50 nm, and if Vc/Vd is less than 2, Rth may become less than 1 nm.

In a case where a so-called touch roller method, the front surface of the touch roller may be rubber or a resin such as TEFLON (registered trademark) or may be a metal roller. If the thickness of the metal roll is caused to be thin, the front surface of the roller is slightly depressed due to the pressure at the time of the touch, the pressure bonding area increases, and thus a roller called a flexible roller can be used.

The touch roller temperature is preferably Tg −70° C. to Tg +20° C., more preferably Tg −50° C. to Tg +10° C., and even more preferably Tg −30° C. to Tg +5° C.

<Stretching>

The casting film (unstretched raw film) extruded to the casting drum as described above may be stretched in at least one axis direction of the vertical direction (MD) or the horizontal direction (TD). It is more preferable that the casting film is biaxially stretched in the vertical direction (MD) and the horizontal direction (TD). In a case where the casting film is biaxially stretched in the vertical direction and the horizontal direction, the stretching may be performed sequentially such as vertical to horizontal or horizontal to vertical, or the stretching may be performed in two directions at the same time. It is preferable that stretching is performed in multiple stages, for example, vertically, vertically, and horizontally; vertically, horizontally, and vertically; or vertically, horizontally, and horizontally.

The vertical stretching can be obtained by generally installing two pairs or more nip rollers, causing the raw film to pass through the nip rollers, and causing a peripheral speed of the nip rollers on the outlet side to be faster than that of the nip rollers on the inlet side.

The horizontal stretching is preferably performed by using a tenter. That is, the horizontal stretching can be performed by holding both ends of the film with clips, transporting heating zones, and widening the clips.

Preferable stretching ratios in respective vertical and horizontal directions are preferably 1.05 times to 8 times and more preferably 1.1 times to 6 times. The stretching temperature is Tg −20° C. to Tg +80° C. and more preferably Tg to Tg +50° C. Accordingly, the birefringence can be exhibited, brittleness can be improved, or the film can be thinned.

The extension of the molecules by stretching can increase interlocking between the molecules and increase the strength of folding endurance. Before the stretching, respective molecules are rounded, and thus interlocking therebetween is small. However, if the stretching is performed, the molecules are extended such that the adjacent molecules can be interconnected. Therefore, in view of the increase of the number of times of folding endurance, the stretching ratio is preferably 1.1 times to 5 times, more preferably 1.5 times to 4 times, and even more preferably 1.8 times to 3.5 times with respect to at least one thereof. The stretching may be uniaxially performed or biaxially performed. However, it is preferable to perform the stretching biaxially, since the molecules are interlocked. If the stretching ratio is less than 1.1 times, the number of times of folding endurance may become less than 50 times. If the stretching ratio is greater than 5 times, the molecules are in the stretched state (becomes brittle), the number of times of folding endurance becomes less than 50 times.

According to the stretching, Rth easily increases. That is, it is assumed that this is because, when the thickness decreases according to the stretching, the film is compressed in the surface direction and the plane orientation progresses. In order to suppress this, it is effective to cause the temperature in the second half of the stretching to be higher than the temperature in the first half of the stretching. The molecules are expanded at low temperature at the initial stage of the stretching and the temperature is increased in order to loosen the molecules plane-oriented at the latter stage of the stretching. Accordingly, the increase of the strength of folding endurance and the Rth suppress can become compatible with each other.

The temperature in the first half of the stretching is preferably Tg to (Tg +50)° C., more preferably (Tg +5)° C. to (Tg +45)° C., and even more preferably (Tg +10)° C. to (Tg +40)° C.

The temperature in the second half of the stretching is higher than the temperature in the first half of the stretching preferably by 1° C. to 30° C., more preferably 2° C. to 25° C., and even more preferably 3° C. to 20° C. The temperature in the first half of the stretching and the temperature in the second half of the stretching described herein refer to the average temperatures on the first half and the second half which are obtained by dividing the stretching step to two equal parts. With respect to the temperature in the second half of the stretching, for the temperature inclination like this, plural heat sources (for example, IR heaters, halogen heaters, panel heaters, and hot air blowing out ports) are arranged in the stretching zone in the flowing direction such that these temperatures increase as the stretching ends. If the difference between the temperature in the first half and the temperature in the second half of the stretching is less than the range above, Rth easily increases. Meanwhile, if the difference between the temperature in the first half and the temperature in the second half of the stretching is greater than the range above, the stretching temperature in the second half becomes too high, such that the number of times of folding endurance may decrease.

The temperature inclination in the stretching like this may be performed in both of the vertical stretching and the horizontal stretching. In a case of biaxial stretching, temperature inclination may be performed in both of the vertical and the horizontal stretching or may be performed in any one of the vertical and the horizontal stretching. It is more preferable that the temperature inclination is performed in the horizontal stretching after vertical stretching. This is because, if the temperature inclination is performed in the horizontal stretching step when the film is finally stretched, it is easy to remain the structure finally.

The temperature difference between the temperature in the second half of the stretching and the temperature in the first half of the stretching is preferably 1° C. to 50° C., more preferably 1° C. to 40° C., and even more preferably 1° C. to 30° C.

The provision of the inplane distribution of Rth can provide the fluctuation to the stretching speed at the time of stretching. If the speed fluctuation is provided, it is possible to provide orientation unevenness (Rth unevenness) in the stretching direction.

As the stretching speed becomes higher, the molecules are easily expanded and the number of times of folding endurance increases. As the stretching speed becomes lower, the strength of folding endurance is easily lowered, and it becomes possible to also provide the inplane distribution of the number of times of folding endurance by providing the speed fluctuation.

The fluctuation of the stretching speed is preferably 0.1% to 10%, more preferably 0.2% to 5%, and even more preferably 0.3% to 3%. If the fluctuation of the stretching speed is less than 0.1%, the inplane distribution of Rth becomes less than 1% and the distribution of the number of times of folding endurance becomes less than 3%. Meanwhile, if the fluctuation of the stretching speed becomes greater than 10%, the inplane distribution of Rth becomes greater than 50% and the distribution of the number of times of folding endurance becomes greater than 30%.

In a case of vertical stretching, the stretching speed fluctuation can be achieved by providing a fluctuation to the electric current value of a drive motor of plural pairs of nip rollers to be used for stretching. In a case of horizontal stretching, the stretching speed fluctuation can be achieved by varying the speed of the drive motor of a chuck that transports the film while the width of the film is increased in the tenter. The cycle of the fluctuation is preferably 0.1 seconds to 30 seconds, more preferably 0.2 seconds to 20 seconds, and even more preferably 0.3 seconds to 10 seconds.

Before the vertical and horizontal stretching, the film may be preheated. The preheating temperature is preferably Tg −50° C. to Tg +30° C., more preferably Tg −40° C. to Tg +15° C., and even more preferably Tg −30° C. to Tg of the resin. The preheating like this may be performed by bringing the film in contact with a heating roller, by using a radiation heat source (a IR heater, a halogen heater, or the like), or by blowing hot air.

After the vertical and horizontal stretching treatments, the heat treatment may be performed to the film. The heat treatment refers to heating the film at about Tg +10° C. to Tg +50° C. (more preferably, at Tg +15° C. to Tg +30° C.) for 1 second to 60 seconds (more preferably for 2 seconds to 30 seconds). At this point, the film may be relaxed by vertically and horizontally shrinking the film. The preferably relaxation rate is 0.5% to 10% in one or both directions of the vertical and horizontal directions.

<Coating>

At either or both of the times of before and after the stretching, coating may be performed. Accordingly, a function layer such as an easily adhesive layer, a hard coat layer, and an antistatic layer can be provided.

<Winding>

After the film is formed and stretched, it is preferable that both ends thereof are trimmed, and the film is wound. The trimmed portions may be subjected to a pulverization treatment or a pelletization treatment, if necessary, and may be reused as the raw material for the film in the same type or as the raw material for the film in the different type. As a trimming cutter, all types of cutters such as a rotary cutter, a shear blade, or a knife can be used. With respect to the materials, both of carbon steel and stainless steel can be used. In general, if a cemented carbide blades or a ceramic blade is used, it is preferable since a life span of the cutter is long.

It is preferable to attach a laminate film on at least one surface before the winding, in view of preventing scratches. The preferable winding tension is 1 kg/m to 50 kg/m in width, more preferably 2 kg/m to 40 kg/m in width, and even more preferably 3 kg/m to 20 kg/m in width. If the winding tension is 1 kg/m or greater of the width, it is preferable since it is easy to evenly wind the film. If the winding tension is 50 kg/m or less in width, the film is not rolled and the winding appearance can be maintained to be beautiful.

After the film is formed, the film may be cooled to room temperature. In the course of cooling the film to room temperature (in a case where stretching is also performed after the film is formed, in the course of cooling to room temperature after stretching), the film is cooled from the temperature of Tg or greater to room temperature. However, it is preferable to provide the temperature difference on one surface (front surface) of the film and a surface opposite thereto (back surface) during cooling from (Tg −20)° C. to (Tg −40)° C. in the course thereof. A difference between the front surface and the opposite surface in thermal expansion amounts is generated, by providing the temperature difference on the front and back surfaces of the film, deformation is formed by the dimension difference and becomes remaining deformation. Due to the exhibition of the remaining deformation, the distribution of the dimension shrinkage of the transparent film in the acceleration test at 125° C. 40% Rh can become 0.005% to 0.5%.

In the high temperature near Tg or greater, the mobility of the molecule is great, the remaining deformation is immediately cancelled, and the dimension shrinkage above is not exhibited. In the temperature that is significantly lower than Tg, the thermal expansion amount is small, and deformation on the front and back surface of the film is hardly generated. Accordingly, it is preferable to provide temperature difference to the front and back surfaces of the film at (Tg −20)° C. to (Tg −40)° C.

The temperature difference is preferably 0.1° C. to 10° C., more preferably 0.2° C. to 5° C., and even more preferably 0.3° C. to 2° C. If the temperature difference is less than 0.1° C., the dimension shrinkage above may become less than 0.01%, and if the temperature difference is greater than 10° C., the dimension shrinkage above may become greater than 0.3%.

A method of providing a temperature difference to the front and back surfaces of the film is not particularly limited. For example, the front surface and the back surface of the film may be caused to be in contact with rollers having different temperatures, temperatures of the heaters provided on the front and back sides may be caused to be different, or temperatures of hot air blowing out nozzles can be caused to be different by providing the hot air blowing out nozzles on the front and back surfaces of the film.

When providing the temperature difference to the front and back surfaces of the film while the temperature is cooled from (Tg −20)° C. to (Tg −40)° C., it is preferable to provide the fluctuation to the transport tension. Accordingly, in addition to the dimension shrinkage difference on the front and back surfaces of the film, fluctuations are added to the dimension difference caused by the tension, such that the dimension shrinkage at 125° C. 40% Rh can be distributed in the surface of the film.

The tension fluctuation is preferably 0.1% to 5%, more preferably 0.2% to 3%, and even more preferably 0.3% to 2%. If the tension fluctuation is less than 0.1%, the distribution of the dimension shrinkage above can be caused to be less than 0.01%, and if the tension fluctuation is greater than 5%, the distribution of the dimension shrinkage above may become greater than 0.3%.

With respect to the method of providing the tension fluctuation, the tension fluctuation can be provided by providing the fluctuation in a vertical direction to a torque of a motor that drives a winding roller or providing the fluctuation in a width direction for causing roughness of the front surface of a transporting roller to be distributed (which can be achieved by grinding the front surface) and providing the fluctuation to friction between the film and the roller.

With respect to the tension fluctuation, the tension of slits divided into ten equal parts in the width direction are measured, the minimum value is subtracted from the maximum value of the ten parts, is divided by the average value of the ten parts, and indicated by percentage, so as to obtain the horizontal (TD) fluctuation. The tension is measured in the center portion in the width direction for one minute, the minimum value is subtracted from the maximum value and divided by the average value for one minute, so as to obtain the vertical (MD) fluctuation.

(Transparent Conductive Film)

The transparent film of the invention can be used in the transparent conductive film. The transparent conductive film has the conductive layer, and the transparent film of the invention as the transparent resin film. The conductive layer may be formed into the layered shape, but preferably formed to have an intermittent portion. The intermittent portion refers to a portion to which the conductive layer is not provided, and the circumference of the intermittent portion is preferably surrounded by the conductive layer. According to the invention, forming the conductive layer so as to have the intermittent portion can be also referred to as forming the conductive layer in the pattern shape or the mesh shape. As the conductive layer, for example, conductive layers disclosed in JP2013-1009A, JP2012-216550A, JP2012-151095A, JP2012-25158A, JP2011-253546A, JP2011-197754A, JP2011-34806A, JP2010-198799A, JP2009-277466A, JP2012-216550A, JP2012-151095A, WO2010/140275A, and WO2010/114056A can be exemplified.

It is more preferable that the conductive layer used in the invention includes silver and a hydrophilic resin. Examples of the water soluble resin include gelatin, polyvinyl alcohol (PVA), polyvinylpyrrolidone (PVP), polysaccharides such as starch, cellulose and derivatives thereof, polyethyleneoxide, polyvinylamine, chitosan, polylysine, polyacrylic acid, polyalginic acid, polyhyaluronic acid, and carboxy cellulose. These have neutral properties, anionic properties, and cationic properties according to the ionicity of the functional group. Among these, gelatin is particularly preferable.

As the conductive layer used in the invention, a conductive layer having organic properties (for example, a conductive resin such as polythiol) or inorganic properties (for example, a semiconductor such as ITO, and metal such as gold, silver, and copper) may be used. Among these, a highly conductive inorganic layer is preferable, and metal is more preferable.

As the conductive layer using the conductive resin, conductive layers disclosed in WO12/061967A, WO2012/120949A, WO2011/105148A, WO2011/093332A, WO2010/092953A, WO2006/070801A, JP53663953B, and JP5298491B can be used.

As the conductive layer using the inorganic semiconductor, conductive layers disclosed in WO2013/175807A, WO2013/111672A, WO2013/105654A, WO2013/099736A, WO2012/074021A, JP5213694B, JP5118309B, JP4486715B, and JP4066132B can be used.

As the conductive layer using metal, conductive layers disclosed in WO2013/141275A, WO2013/099736A, WO2012/176407A, WO2011/027583A, JP5142223B, JP5112492B, JP4893587B, JP4733184B, JP3960850B, JP5129711B, JP4914309B, and JP3785086B can be used.

In the conductive layer used in the invention, a silver halide photographing sensitive material is particularly preferable. In a case where the silver halide photographing sensitive material is used, the manufacturing method for the conductive layer includes three embodiments of the photosensitive material and the development treatment, as follows.

(1) An aspect of chemically or thermally developing a photosensitive silver halide black and white photosensitive material not including a physical development nuclei and forming a metallic silver portion on the photosensitive material above.

(2) An aspect of dissolving and physically developing a photosensitive silver halide black and white photosensitive material including physical development nuclei in a silver halide emulsion layer and forming a metallic silver portion on the photosensitive material above.

(3) An aspect of overlapping an image receiving sheet having a photosensitive silver halide black and white photosensitive material not including a physical development nuclei and a non-photosensitive layer including a physical development nuclei, performing diffusion transfer development, and forming a metallic silver portion on the non-photosensitive image receiving sheet.

Aspect (1) above is an integrated black and white developing type, and a light transmissive conductive film such as a light transmitting conductive film is formed on the photosensitive material. Since the obtained developable silver is chemically developable silver or thermally developable silver and is a filament having high specific surface, the developable silver has high activity in the course of the plating or the physical development described below.

In Aspect (2) above, silver halide particles closely relative to the physical development nuclei are dissolved in an exposed portion are dissolved and deposited on the development nuclei, and the light transmissive conductive film such as the light transmitting conductive film is formed on the photosensitive material. This is also the integrated black and white development type. The development activity is precipitation on the physical development nuclei, and thus highly active, but the developable silver has a spherical shape having a small specific surface.

In Aspect (3) above, a light transmissive conductive film such as the light transmitting conductive film is formed on the image receiving sheet, by dissolving and diffusing silver halide particles in the unexposed portion and depositing the silver halide particles on the development nuclei on the image receiving sheet. This is a so-called separate type, and is an aspect of separating the image receiving sheet from the photosensitive material to use.

In all aspects, all the development of a negative-type development treatment and a reversal development treatment can be selected. In the case of the diffusion transfer type, a negative type development treatment can be performed by using an autopositive-type photosensitive material as a photosensitive material.

The chemical development, the thermal development, the dissolution and physical development, and the diffusion transfer development described herein have the same meanings as generally used in the related art and are explained in general textbooks of photographic chemical, for example, “Photographic Chemical” written by Kikuchi Shinichi (Kyoritsu Shuppan Co., Ltd., issued in 1955) and “The Theory of Photographic Processes, 4th ed.” edited by C. E. K. Mees (McMillan, issued in 1977). This specification is an invention related to the liquid treatment, but techniques of applying a thermal development method as another development method can be referred to. For example, techniques disclosed in JP2004-184693A, JP2004-334077A, JP2005-010752A, JP2004-244080, and JP2004-085655 can be applied.

The silver halide emulsion layer that becomes the conductive layer according to the invention may contain additives such as a solvent or a dye, in addition to the silver halide and the binder. Examples of the silver halide include inorganic silver halide such as silver halide and organic silver halide such as silver acetate. According to the invention, it is preferable to use silver halide having excellent characteristics as an optical sensor.

The solvent used in the formation of the silver halide emulsion layer is not particularly limited, but examples thereof include water, an organic solvent (for example, alcohols such as methanol, ketones such as acetone, amides such as formamide, sulfoxides such as dimethylsulfoxide, esters such as ethyl acetate, and ethers), ionic liquid, and mixed solvents thereof.

A protective layer may be provided on the silver halide emulsion layer. The protective layer according to the invention means a layer consisting of gelatin or a binder called a high molecular polymer and is formed on the silver halide emulsion layer having photosensitivity, in order to exhibit an effect of improving scratch prevention and mechanical characteristics. The thickness thereof is preferably 0.5 μm or less. The coating method and the forming method for the protective layer are not particularly limited, but well-known coating methods and well-known forming methods can be appropriately selected. For example, with respect to the protective layer, disclosure in JP2008-250233A can be referred to.

The conductive layer may be provided on the entire surface of the transparent film and may be patterned on the thin wire or the like. If the conductive layer is patterned, it is preferable since high transparency can be easily obtained, and if the conductive layer is patterned with Ag, it is particularly preferable since transparency and conductivity are excellent. Since Ag has sufficient flexibility, disconnection is hardly generated even if patterning is formed on the unevenness above, and thus Ag is more preferable.

Among Ag wiring, wiring formed of silver halide is more preferable. Since patterning is performed by exposure, thin wires can be easily formed, a gradation effect caused by the unevenness of the front surface is easily obtained, and transparency can be increased. Examples of the Ag wiring formed of silver halide include JP2012-234659A, JP2012-230665A, JP5347037B, JP2012-230664A, WO2012/098992A, JP2012-221891A, JP2012-218402A, JP2012-198879A, WO2012/121064A, JP2012-194887A, JP5345980B, JP2012-6377A, JP2012-4042A, JP2009-259479A, and JP2006-352073A.

The width of the thin wire is preferably 0.1 μm to 50 μm, more preferably 0.3 μm to 30 μm, and even more preferably 0.515 μm. If the width of the thin wire is less than 0.1 μm, the thin wire is easily broken, and if the width thereof is greater than 50 μm, the gradation effect due to the unevenness of the front surface is hardly exhibited.

According to the invention, other function layers such as an undercoat layer or an antistatic layer may be provided. As the undercoat layer, undercoat layers disclosed in paragraphs “0021” to “0023” of JP2008-250233A can be applied. As the antistatic layer, antistatic layers disclosed in paragraphs “0012”, “0014” to “0020” of JP2008-250233A can be applied.

(Touch Panel)

The transparent conductive film according to the invention can be used in the touch panel.

The touch panel having the transparent conductive film according to the invention is not particularly limited, and can be appropriately selected according to the purposes. Examples thereof include a front surface-type electrostatic capacitive touch panel, a projection-type electrostatic capacitive touch panel, and a resistance film-type touch panel. The touch panel includes a so-called touch sensor and a so-called touch pad. The layer configuration of an electrode portion of the touch panel sensor in the touch panel is any one of a sticking method of sticking two sheets of the transparent electrodes, a method of providing transparent electrodes on both surfaces of one sheet of the substrate, a single-sided jumper method, a through-hole method, or a single-sided laminating method. In addition, the projection type electrostatic capacitive touch panel is preferably driven by AC than by DC, and a driving method with short application time to the electrode is more preferable.

(Anti-Reflection Film)

The transparent film of the invention can be used as the support of the anti-reflection film. In a case of an image display device with high resolution and high quality such as a liquid crystal display device (LCD), in addition to the dust resistance described above, it is preferable to use an anti-reflection film having transparent and antistatic performance for preventing contrast decrease due to the reflection of the external light on the displaying surface and the glare of the image.

(Polarization Plate)

The transparent film of the invention can be used in the polarization plate. The polarization plate according to the invention has a polarizer and a protective film provided on both surfaces of the polarizer above, and the transparent film of the invention can be used as at least one side of the protective film above. It is preferable that the transparent film has a contact angle of water to the front surface of the transparent support on the opposite side of the side that has a light scattering layer or an anti-reflection layer, that is, the front surface on the side bonded to the polarizer in the range of 10° to 50°. For example, an adhesive layer is provided on one surface of the transparent film of the invention and can be arranged on the outermost front surface of the display.

(Display Device)

The transparent film of the invention or the polarization plate having the transparent film of the invention described above can be used in various display devices such as a liquid crystal display device (LCD), a plasma display panel (PDP), an electroluminescence display (ELD), and a cathode tube display device (CRT). The transparent film or the polarization plate of the invention is preferably arranged on the visible side of the display surface of the image display device.

(Liquid Crystal Display Device)

The transparent film or the polarization plate of the invention is particularly preferably used on the outermost layer of the display such as the liquid crystal display device. The liquid crystal display device has a liquid crystal cell and two sheets of polarization plates arranged on both surfaces of the liquid crystal cell, and the liquid crystal cell contains the liquid crystal between two sheets of the electrode substrates. One optical anisotropic layer is arranged between the liquid crystal cell and one of the polarization plate, or two optical anisotropic layers are arranged between the liquid crystal cell and both of the polarization plates.

The liquid crystal cell is preferably in a TN mode, a VA mode, an OCB mode, an IPS mode, or an ECB mode.

In the liquid crystal cell in the TN mode, a rod-shaped liquid crystalline molecule is substantially horizontally oriented when the voltage is not applied and is further twisted and oriented to 60° to 120°.

The liquid crystal cell of the TN mode is most widely used as a color TFT liquid crystal display device and is disclosed in various documents.

In the liquid crystal cell in the VA mode, the rod-shaped liquid crystalline molecule when the voltage is not applied is substantially vertically orientated.

The liquid crystal cell in the VA mode includes (1) the liquid crystal cell in the VA mode in a narrow sense (disclosed in JP1990-176625A (JP-H02-176625A)) obtained by substantially vertically orienting the rod-shaped liquid crystalline molecule when the voltage is not applied and substantially horizontally orientating the rod-shaped liquid crystalline molecule when the voltage is applied, (2) the liquid crystal cell (in the MVA mode) in which the VA mode is changed to a multi domain for viewing angle expansion (disclosed in SID97, Digest of Tech. Papers (preliminary draft) 28 (1997) 845), and (3) the liquid crystal cell (disclosed in preliminary draft 58 to 59 (1998) of Japanese Liquid Crystal Conference) in a mode (n-ASM mode) of substantially vertically orienting the rod-shaped liquid crystalline molecule when the voltage is not applied and twisting the rod-shaped liquid crystalline molecule to the multi domain orientation when the voltage is applied, and (4) the liquid crystal cell in a survival mode (issued in LCD International 98).

The liquid crystal cell in the OCB mode is a liquid crystal cell in a band orientation mode of orienting the rod-shaped liquid crystalline molecule in the substantially reverse direction (symmetrically) on the upper portion and the lower portion of the liquid crystal cell and is disclosed in U.S. Pat. No. 4,583,825A and U.S. Pat. No. 5,410,422A. Since the rod-shaped liquid crystalline molecule is symmetrically oriented on the upper portion and the lower portion of the liquid crystal cell, the liquid crystal cell in the band orientation mode has a self optical compensation function. Therefore, the liquid crystal mode is called an optically compensatory bend (OCB) liquid crystal mode. The liquid crystal display device in the band orientation mode has an advantage of having fast response speed.

The liquid crystal cell in the IPS mode is a method of performing switching by applying a horizontal field effect to nematic liquid crystal, and specifically disclosed in pages 577 to 580 and pages 707 to 710 of Proc. IDRC (Asia Display '95).

In the liquid crystal cell in the ECB mode, the rod-shaped liquid crystalline molecule is substantially horizontally oriented when the voltage is not applied. The ECB mode is one of the liquid crystal displaying mode having the simplest structure, and details thereof are disclosed, for example, in JP1993-203946A (JP-H05-203946A).

<Plasma Display Panel (PDP)>

The plasma display panel (PDP) is generally formed of gas, a glass substrate, an electrode, an electrode lead material, and a thick film printing material, and a fluorescent body. The glass substrate is formed of two sheets of a front surface glass substrate and a rear surface glass substrate. An electrode and an insulating layer are formed on the two sheets of glass substrates. A fluorescent body layer is further formed on the rear surface glass substrate. Two glass substrates are assembled, and gas is sealed therebetween.

The plasma display panel (PDP) can be obtained by using a plasma display panel which is commercially available. The plasma display panel is disclosed in JP1993-205643A (JP-H05-205643A) and JP1997-306366A (JP-H09-306366A).

A front surface plate may be arranged on the front surface of the plasma display panel. It is preferable that the front surface plate includes sufficient strength for protecting a plasma display panel. The front surface plate may have a gap with the plasma display panel to be used or may be directly bonded to the main body of the plasma display.

In the image display device such as the plasma display panel, an optical filter may be directly bonded to the front surface of the display. In a case where the front surface plate is provided before the display, the optical filter can be attached to the front side (outer side) or the rear side (display side) of the front surface plate.

<Organic EL Element>

The transparent film of the invention may be used as a substrate (substrate film) or a protective film of an organic EL element or the like. In a case where the film of the invention is used in the organic EL element or the like, contents of JP1999-335661A (JP-H11-335661A), JP1999-335368A (JP-H11-335368A), JP2001-192651A, JP2001-192652A, JP2001-192653A, JP2001-335776A, JP2001-247859A, JP2001-181616A, JP2001-181617A, JP2002-181816A, JP2002-181617A, and JP2002-056976A can be applied. It is preferable to use contents of JP2001-148291A, JP2001-221916A, and JP2001-231443A together.

### EXAMPLES

Hereinafter, the characteristics of the invention are described in greater detail with reference to examples and comparative examples. Materials, amounts used, ratios, treatment details, treatment orders, and the like that are represented in the examples below can be appropriately changed without departing from the gist of the invention. Accordingly, the scope of the invention is not construed in a limited manner by specific examples represented below.

(1) Measuring Method for Rth and Inplane Distribution of Rth

<Rth>

Rth was measured at a light wavelength of 550 nm by using KOBRA 21ADH or WR manufactured by Oji Scientific Instruments. An angle between incident ray and the surface of the film was changed gradually, phase values were measured at the respective angles, curve fitting was performed in an expression of an ellipsoid body of a refractive index well-known in the art to obtain nx, ny, and nz which are three dimensional refractive indexes, and nx, ny, and nz were substituted to Rth={(nx+ny)/2−nz}×d such that Rth was obtained. At this point, the average refractive index of the film was required and was measured by using an Abbe's refractometer (“Abbe's refractometer 2-T” Product Name of Atago Co., Ltd.).

Rth obtained in this manner was normalized to 100 μm as below.

Rth normalized to 100 μm=(measured Rth)/(thickness(μm)/100)

<Inplane Distribution of Rth>

Rth was measured at ten points arbitrarily selected from the sample film of 30 cm×20 cm in the method described above, and inplane distribution of Rth was measured from the following expression below.

Inplane distribution of Rth (%)=100×(maximum value−minimum value)/average value

(2) Glass Transition Temperature (T)

The glass transition temperature (T) was measured at a temperature elevation speed of 10° C./minutes by using 2920-type DSC manufactured by TA Instruments, as below.

After the temperature of the sample film was increased from the room temperature to 300° C. at 20° C./minutes under nitrogen atmosphere, the sample was extracted, immersed in nitrogen, and cooled. After the sample was obtained and the temperature thereof was returned to room temperature, while the temperature thereof was increased from 30° C. to 300° C. at 10° C./minutes under nitrogen atmosphere, the temperature was measured and inflection points were obtained as the glass transition temperature.

(3) Equilibrium Moisture Content (Y) at 25° C.

After the sample film was immersed for one night in pure water at 25° C. and removed from the water, moisture on the front surface was quickly wiped out, and moisture was measured at the vaporization temperature of 120° C. by using the Karl Fischer moisture meter (manufactured by Kyoto Electronics Manufacturing Co., Ltd., MKC-520).

(4) Dimension Shrinkage Rate at 125° C. 40% Rh, and Distribution of Dimension Shrinkage Rate (Dimension Rate)

Ten samples (MD samples) of which the long sides were parallel in the vertical direction (MD) and ten samples (TD samples) of which the long sides were parallel in the horizontal direction (TD) were cut into 25 cm×5 cm from an arbitrary position.

After the respective samples were left at 25° C. 60% Rh for one night, holes were made at the interval of 20 cm, and the lengths thereof were measured by using a pin gauge (set to L1).

In the method below, the samples above were put in a thermohygrostat set at 125° C. 40% Rh under no tension for ten minutes and extracted. In order to set the thermohygrostat at 125° C. 40% Rh, 125° C. 40% Rh was achieved by introducing the saturated pressured steam at 125° C. to the air thermostatic bath set to 125° C. and adjusting the introducing amount thereof.

After the samples were left at 25° C. 60% Rh for one night, the pin gauge was used and the lengths thereof were measured (set to L2).

The dimension shrinkage rates were obtained from the expression below with respect to the respective samples, the average values of the twenty samples in total of MD and TD were set to “dimension shrinkage rates” of the invention.

Dimension shrinkage rate (%)=100×|L2−L1|/L1

(In the expression above, | | represents an absolute value)

The distribution of the dimension shrinkage was obtained from the expression below for each of MD and TD, and the greater value was set to be the distribution of the dimension shrinkage rate.

Distribution of dimension shrinkage rate (%)=(maximum value of dimension shrinkage rate)−(minimum value of dimension shrinkage rate)

(5) The Number of Times of Folding Endurance, and Inplane Distribution of the Number of Times of Folding Endurance

<The Number of Times of Folding Endurance>

A folding test was performed by a MIT tester according to JIS P8115.

<Inplane Distribution of the Number of Times of Folding Endurance>

The measurement above was performed at ten points for each of MD and TD.

The distribution was obtained for each of MD and TD in the expression below (MD distribution and TD distribution), and the average values of MD distribution and TD distribution were set to the distribution of the number of times of folding endurance.

MD distribution of the number of times of folding endurance (%)=100×(Maximum value of MD−Minimum value of MD)/(Average value of ten points in MD)

TD distribution of the number of times of folding endurance (%)=100×(Maximum value of TD−Minimum value of TD)/(Average value of ten points in TD)

(6) Total Light Transmittance

Total light transmittance was measured by using a haze meter (NDH 2000: manufactured by Nippon Denshoku Industries Co., Ltd.).

(7) Shredded Waste

Ten sheets of sample films in the square having one side of 10 cm were punched, four cut sides were rubbed by black paper, and the number of white powder separated from the sample was visually counted.

(8) Foreign Substances

In the arbitrarily selected films of 25 cm×25 cm, foreign substances in 16 sheets were visually evaluated, and the total number thereof was set to the number of foreign substances in 1 m².

(9) Increase of Electric Resistance of Conductive Layer (Increase Ratio of Electric Resistance after Thermo Treatment)

The initial electric resistance of the transparent conductive layer was measured by the method below (electric resistance measuring method) (Ω1). This was exposed to 125° C. 40% Rh for 10 minutes, the temperature was returned to room temperature, the electric resistance was measured (Ω2), and the resistance increase rate was obtained from the expression below.

Resistance increase rate (%)=100×(Ω2−Ω1)/Ω1

Electric resistance measuring method: Electric resistance was measured at arbitrary ten points of the conductive film, by using LORESTA manufactured by Mitsubishi Chemical Analytech Co., Ltd. (using four scanning probes in series), so as to obtain the average value thereof. If cracks were generated, resistance increase rates increases, cracks became standards.

(10) Visibility of Conductive Wiring (Wiring Visibility)

After the touch panel was assembled as described below, the wiring of the transparent conductive layer was visually observed, evaluation in five stages of 0 to 4 was performed.

0: Wiring was not recognized at all

1: Wiring was slightly recognized under enforcement condition (under high brightness illumination)

2: Wiring was slightly recognized.

3: A half of people who looked the touch panel or more were able to recognize wiring

4: Wiring was able to be clearly recognized.

In the examples, abbreviations below indicate following compounds and resins.

TOPAS-6013: cyclic olefin-based resin (manufactured by Polyplastics Co., Ltd.)

TOPAS-6015: Cyclic olefin-based resin (manufactured by Polyplastics Co., Ltd.)

TOPAS-6017: Cyclic olefin-based resin (manufactured by Polyplastics Co., Ltd.)

PC: Polycarbonate (manufactured by Mitsubishi Engineering-Plastics Corporation, IUPILON)

PEI: Polyetherimide (manufactured by Saudi Basic Industries Corporation, ULTEM)

PAr: Polyarylate (manufactured by Unitika Ltd., U polymer)

PSt: Polystyrene (manufactured by PS Japan Corporation, polystyrene HF77)

PMMA: Polymethacrylate (manufactured by Mitsubishi Rayon Co., Ltd., ACRYPET)

PEN: Polyethylene naphthalate, Polymerization in conformity with Example 1 of JP1996-160565A (JP-H08-160565A)

COC-3: Norbomene polymer, Polymerization in conformity with Manufacturing Example 1 of WO2009/139293A

COC-2: Norbornene polymer, polymerization in conformity with Manufacturing Example 1 of WO2009/139293A, but the norbornene concentration in toluene was set to 35 mass %.

COC-1: Norbornene polymer, polymerization in conformity with Manufacturing Example 1 of WO2009/139293A, but the norbornene concentration in toluene was set to 32 mass %.

PSf: (Polysulfone, manufactured by Solvay, UDEL P-3500)

Modified polycarbonate (modified PC): Resin of Comparative Example 1 of JP2002-328614A

TABLE 2

| | T(° C.) | Y(%) |
|---|---|---|
| TOPAS 6013 | 135 | 0.01 |
| TOPAS 6015 | 154 | 0.01 |
| TOPAS 6017 | 173 | 0.01 |
| PC | 140 | 0.2 |
| PSf | 180 | 0.3 |
| PEI | 200 | 0.25 |
| PAr | 190 | 0.2 |
| PSt | 100 | 0.04 |
| PMMA | 100 | 0.35 |
| PEN | 125 | 0.30 |
| COC-3 | 169 | 0.01 |
| COC-2 | 146 | 0.01 |
| COC-1 | 138 | 0.01 |
| Modified PC | 155 | 0.4 |

### Manufacturing of Transparent Film

### Examples 1 to 63 and Comparative Examples 1 to 11

<Drying>

The resins used in the respective example and the respective comparative examples are dried. In a case where the resins to be used of which the glass transition temperatures (T) of 130° C. or greater are used, the resins are dried at 110° C. for 3 hours, and in a case where the resins to be used of which the glass transition temperatures (T) of less than 130° C. are used, the resins are dried at Tg −20° C. for 8 hours.

<Melt Extrusion>

Melt viscosity of the resins to be used in the respective example and the respective comparative examples was measured by a cone plate viscometer in advance, the temperature in which the viscosity became 1,000 Pa·s at the shearing speed of 10 s⁻¹ was obtained, and the obtained temperature was set to be MT.

The resins were kneaded by using a single screw extruder in which a barrel temperature was set to MT, were roughly filtered with a screen mesh, and was guided to the T die through a gear pump, a filtration device (hole diameter: 3 μm), and a static mixer. Inside the T die, with respect to the entire width, steps described in Tables 3 and 4 below are provided, and a discharge fluctuation presented in Tables 3 and 4 below was provided to the supplying amount of the resin to the T die.

<Casting>

The temperatures of the resins from the T die were adjusted to (Tg −10)° C. of the resins used in the respective examples and the respective comparative examples were discharged to the casting drum and solidified, so as to form films. Specific conditions of the T die or the like were set as below.
Split heaters were installed to the T die, the output was fluctuated, the average temperature of the T die was set to the temperature which was the same as the extrusion temperature, and the temperature distribution presented in Tables 3 and 4 below were provided.
The lip gap fluctuation of the T die was set to rates (%) presented in Tables 3 and 4 below.
The ratios of the discharge speed (Vd) of the resin at the T die outlet and the speed (peripheral speed) (Vc) of the casting drum were set as presented in Tables 3 and 4 below.
Unevenness of the die lines was corrected by interposing the resins used in the respective examples and the respective comparative examples which were discharged to the touch rollers installed on the opposite surface of the casting rollers.
Cooling was performed by installing rollers set to Tg −15° C. (second roller), Tg −20° C. (third roller), and Tg −40° C. (fourth roller) after the casting rollers and transporting the film on the rollers. Hot air blowing out ports were installed between the second and third rollers, temperature difference presented in the tables below was provided to the front and back surfaces between the third and fourth rollers, and the tension fluctuation from Tg −20° C. (third roller) to Tg −40° C. (fourth roller) was performed as Tables 3 and 4.

Before the film was wound, the film was trimmed by 50 mm on left and right sides, knurling was provided to portions of 1 cm from the both ends, a laminate film of 20 μm was attached to one surface, and the film having the width of 1.5 m and the length of 1,500 m was wound. In this manner, the films formed in the examples and the comparative examples were manufactured.

### Manufacturing of Transparent Film

### Example 101

A transparent film of Example 101 was manufactured in the same manner as in Example 2 except for causing the thickness of the film to be 30 μm.

### Manufactured of Transparent Film

### Examples 102 to 107

Transparent films of Examples 102 to 107 were manufactured in the same manner as in Example 2 except for stretching the films formed in Example 2 in the conditions presented in Table 5 and further causing the thicknesses of the films to be thicknesses as presented in Table 5.

### Manufactured of Transparent Film

### Examples 108 to 112

Transparent films of Examples 108 to 112 were manufactured in the same manner as in Example 1 except for stretching the films formed in Example 1 in the conditions presented in Table 5 and further causing the thicknesses of the films to be 160 μm as presented in Table 5.

### Manufactured of Transparent Film

### Examples 113 to 119

Transparent films of Examples 113 to 119 were manufactured in the same manner as in Example 3 except for stretching the films formed in Example 3 in the conditions presented in Table 5 and further causing the thicknesses of the films to be 112 μm as presented in Table 5.

### Manufactured of Transparent Film

### Comparative Example 12 and Example 120

Transparent films of Comparative Example 12 and Example 120 were manufactured by manufacturing the films in the method disclosed in Example 1 of JP2011-43628A and stretching the films in the conditions described in Table 5 as below. T and Y of the resins used in Comparative Example 12 and Example 120 were 180° C. and 0.02%, respectively.

<Stretching>

While the formed film was transported with the laminate film removed, the horizontal (TD) stretching was performed after the vertical (MD) stretching at Tg +20° C. of the resin described in the table.

A fluctuation described in the tables below was provided to the stretching speed by providing the fluctuation to the number of rotations of the nip rollers on the outlet side in the MD stretching and providing the fluctuation to the number of rotations of the drive motor of the chuck that was transported in the tenter in the TD stretching.

After the stretching, while the film extracted from the tenter became Tg −20° C. to Tg −40° C., the temperature difference was provided to the film by the IR heater installed on the front and back surfaces of the film.

After the stretching, the film was trimmed by 80 mm on left and right sides, knurling was provided to portions of 1 cm from the both ends, a laminate film of 20 μm was attached to one surface, and the film having the length of 1,500 m was wound. In this manner, the formed film was manufactured.

(Evaluation)

The glass transition temperature (T) and the equilibrium moisture content (Y) at 25° C. of the films formed in the examples and the comparative examples above are represented in Tables 3 and 4.

With respect to the films formed in the examples and the comparative examples above, Rth, inplane distribution of Rth, the distribution of the dimension ratio at 125° C. 40% Rh, the number of times of folding endurance, the inplane distribution of the number of times of folding endurance, the dimension shrinkage rate at 125° C. 40% Rh, the total light transmittance, the shredded waste, and the foreign substances were measured in the methods above, and the results thereof were presented in Tables 6 to 8.

(Manufacturing of Transparent Conductive Film)

The conductive layers (AgX) as below were formed on the transparent films of Examples 1 to 60, 63, and 101 to 120 and Comparative Examples 1 to 12.

<Coating of Undercoat Layer>

After the corona treatment was performed on one surfaces of the transparent films of the examples and the comparative examples, which were formed as above, the first undercoat layers and the second undercoat layers were coated. The compositions and the coating methods of the first undercoat layer and the second undercoat layer were as disclosed in “0117” to “0120” of JP2010-256908A.

(Forming of Conductive Layer Including Water Soluble Resin and Silver)

The silver halide photosensitive material below was coated on the undercoat layer above so as to manufacture the transparent conductive film

<Silver Halide Photosensitive Material>

Emulsion including 10.0 g of gelatin with respect to Ag of 150 g in a water medium and containing silver iodobromochloride particles (I=0.2 mol %, Br=40 mol %) having an equivalent spherical diameter average of 0.1 μm was prepared. In this emulsion, K₃Rh₂Br₉ and K₂IrCl₆ were added such that the concentration thereof became 10⁻⁷ (mol/mol Ag), and Rh ions and Ir ions were doped to silver bromide particles. Na₂PdCl₄ was added to this emulsion, gold sulfur sensitization was further performed by using gold chloride and sodium thiosulfate, and this emulsion was coated on the undercoat layer above of the transparent resin film, together with a gelatin hardening agent, such that the coating amount of silver became 10 g/m². At this point, the volume ratio of Ag:gelatin was 2:1.

Coating was performed in the width of 0.7 m for 500 m, both ends were cut out such that 0.5 m of the center portion of coating was remained, and a roller-shaped silver halide photosensitive material was obtained.

<Exposure>

The pattern of the exposure was formed in conformity with the pattern illustrated in FIG. 1 of JP4820451B. An array pitch Ps of small lattices 18 was set to 200 μm, and an array pitch Pm of middle lattices 20a to 20h was set to 2×Ps. The thickness of the conductive portion of the small lattices was set to 2 μm. The mask was adjusted such that the width of the wire became as presented in the tables. The exposure was performed by using parallel light with the high pressure mercury lamp as a light source via a photomask having the pattern above.

The conductive pattern was formed in conformity with FIG. 5 of JP4820451B, but the same results were able to be obtained.

<Development Treatment>

The prescription of 1 L of a developer of was as follows.

| | |
|---|---|
| Hydroquinone | 20 g |
| Sodium sulfite | 50 g |
| Potassium carbonate | 40 g |
| Ethylenediamine•tetraacetic acid | 2 g |
| Potassium bromide | 3 g |
| Polyethylene glycol 2000 | 1 g |
| Potassium hydroxide | 4 g |
| pH was adjusted to 10.3. | |

The prescription of 1 L of a fixing liquid was as below.

| | |
|---|---|
| Ammonium thiosulfate solution (75%) | 300 ml |
| Ammonium sulfite monohydrate | 25 g |
| 1,3-Diaminopropane•tetraacetic acid | 8 g |
| Acetic acid | 5 g |
| Ammonia water (27%) | 1 g |
| pH was adjusted to 6.2. | |

A sensitive material after exposure was completed by using the treating agent above was treated under the treatment conditions: development at 35° C. for 30 seconds, fixation at 34° C. for 23 seconds, and water washing with flowing water (5 L/minutes) for 20 seconds, by using an automatic developing machine FG-710PTS manufactured by Fujifilm Corporation.

(Manufacturing of Transparent Conductive Film)

A conductive layer (ITO) was formed on the transparent film of Example 62 as below.

A conductive film comprising a detection electrode was formed by forming an etching mask material on the ITO transparent conductive layer of the ITO substrate including the transparent film and the ITO transparent conductive layer in the negative photoresist method and performing immersion in the etching liquid in which ITO was dissolved. Hereinafter, an order of the respective steps below is provided.

<Resist Patterning (Etching Mask Material Providing) Step>

Bar coating was performed with a photosensitive composition (1) below on the front surface of the ITO transparent conductive layer such that the dry film thickness became 5 μm, and drying was performed for five minutes in an oven of 150° C. From the exposure glass mask, this substrate was exposed to i rays (365 nm) of a high pressure mercury lamp at 400 mJ/cm² (illuminance: 50 mW/cm²).

The substrate after the exposure was subjected to the shower development of 60 seconds with the 1% sodium hydroxide aqueous solution (35° C.). The shower pressure was 0.08 MPa, and the time until stripe patterns appeared was 30 seconds. After rinsing by the shower of pure water, drying was performed for one minute at 50° C., a conductive member with a resist pattern was manufactured.

As the exposure glass mask, a mask that can form a detection electrode of the electrostatic capacitive touch panel sensor was used. The wire width of the patterned conductive wiring was described in the tables.

<Etching Step>

The conductive member with a resist pattern was immersed in the etching liquid for ITO. Etching was performed by immersing the conductive member in the etching solution of which the temperature was adjusted to 35° C. for two minutes, rinsing was performed by the shower with pure water, water on the front surface of the sample was blown away with an air knife, and drying was performed at 60° C. for 5 minutes such that a pattern-shaped conductive member with a resist pattern was manufactured.

<Resist Separating Step>

The pattern-shaped conductive member with the resist pattern after etching was subjected to the shower development for 75 seconds with a 2.38% tetramethylammonium hydroxide aqueous solution of which the temperature was maintained to 35° C. The shower pressure was 3.0 MPa. After rinsing was performed by the shower with pure water, water on the front surface of the sample was blown away with an air knife, and drying was performed at 60° C. for 5 minutes such that a conductive film was manufactured.

As the conductive films, two sheets of the conductive films (the first conductive film and the second conductive film) were manufactured by changing the patterns of the detection electrode. The detection electrodes of the first conductive film were electrodes (Length: 170 mm) extending in the X direction, and the number of the detection electrodes was 32. The detection electrodes of the second conductive film were electrodes (Length: 300 mm) extending in the Y direction, and the number of the detection electrodes was 56.

<Preparing of Photosensitive Composition (1)>

Methacrylic acid (MAA; 7.79 g) and benzyl methacrylate (BzMA; 37.21 g) were used as the monomer component that forms the copolymer, 2,2′-azobis(isobutyronitrile) (AIBN; 0.5 g) was used as the radical polymerization initiator, and these are subjected to polymerization reaction in a solvent PGMEA (propylene glycol monomethyl ether acetate; 55.00 g), such that the PGMEA solution (solid content concentration: 45 mass %) of a binder (A-1) expressed in the formula below was obtained. The polymerization temperature was adjusted to the temperature of 60° C. to 100° C.

As a result of measuring the molecular weight by using the gel permeation chromatography method (GPC), a weight average molecular weight (Mw) in terms of polystyrene was 30,000, and the molecular weight distribution (Mw/Mn) was 2.21.

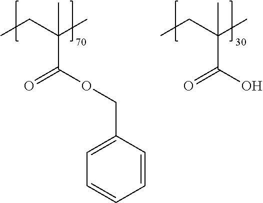

3.80 parts by mass of the binder (A-1) (Solid content: 40.0 mass %, PGMEA solution), 1.59 parts by mass of KAYARAD DPHA (manufactured by Nippon Kayaku Co., Ltd.) as the photosensitive compound, 0.159 parts by mass of IRGACURE 379 (manufactured by Ciba Specialty Chemicals plc.) as a photo polymerization initiator, 0.150 parts by mass of EHPE-3150 (manufactured by Daicel Corporation) as the crosslinking agent, 0.002 parts by mass of MEGAFACE F781F (manufactured by DIC Corporation), and 19.3 parts by mass of PGMEA were added and stirred, such that the photosensitive composition (1) was prepared.

<Forming of Peripheral Wiring>

The lead out wiring (peripheral wiring) that was formed by the patterning and was connected to the detection electrode in the conductive film was manufactured in the manner below. That is, after silver paste (DOTITE FA-401CA, manufactured by Fujikurakasei Co., Ltd.) was printed with a screen printing machine, the silver paste was cured by performing an annealing treatment at 130° C. for 30 minutes, such that the peripheral wiring was formed.

As the screen printing plate, a printing plate on which the peripheral wiring for the electrostatic capacitive touch panel was used can be formed was used.

(Manufacturing of Transparent Conductive Film)

A conductive layer (Ag fiber) was formed on the transparent film of Example 61 as below.

The conductive layer was prepared according to a transparent conductive laminate 1 of the example of WO2013/141275. However, the width of the wiring of the conductive film was adjusted so as to be the values presented in the tables.

With respect to the transparent conductive film manufactured above, results obtained by evaluating the increase of the electric resistance of the conductive layer (the increase rate of the electric resistance after the thermo treatment), and the visibility of the conductive wiring (wiring visibility) were presented in Tables 6 to 8.

TABLE 3

| | | Film forming | | | | | |
|---|---|---|---|---|---|---|---|
| | | | | Discharge | | Die temperature | Lip gap |
| | Resin | | | fluctuation | Step(s) in die | distribution | fluctuation |
| | Type | T ° C. | Y % | % | mm | ° C. | % |
| Example 1 | TOPAS 6013 | 132 | 0.01 | 3 | 1 | 5 | 8 |
| Example 2 | TOPAS 6015 | 154 | 0.01 | 3 | 1 | 5 | 8 |
| Example 3 | TOPAS 6017 | 173 | 0.01 | 3 | 1 | 5 | 8 |
| Example 4 | PC | 135 | 0.2 | 3 | 1 | 5 | 8 |
| Example 5 | PSf | 180 | 0.3 | 3 | 1 | 5 | 8 |
| Example 6 | PAr | 190 | 0.2 | 3 | 1 | 5 | 8 |
| Example 7 | PEI | 200 | 0.25 | 3 | 1 | 5 | 8 |
| Comparative | PSt | 100 | 0.04 | 3 | 1 | 5 | 8 |
| Example 1 | | | | | | | |
| Comparative | PMMA | 100 | 0.35 | 3 | 1 | 5 | 8 |
| Example 2 | | | | | | | |
| Comparative | PEN | 125 | 0.3 | 3 | 1 | 5 | 8 |
| Example 3 | | | | | | | |
| Comparative | Modified PC | 155 | 0.4 | 3 | 1 | 5 | 8 |
| Example 4 | | | | | | | |
| Example 8 | COC-1 | 141 | 0.01 | 3 | 1 | 5 | 8 |
| Example 9 | COC-2 | 146 | 0.01 | 3 | 1 | 5 | 8 |
| Example 10 | COC-3 | 169 | 0.01 | 3 | 1 | 5 | 8 |
| Comparative | COC-2 | 146 | 0.2 | 0.5 | 3 | 10 | 3 |
| Example 5 | | | | | | | |
| Example 11 | COC-2 | 146 | 0.2 | 0.5 | 3 | 10 | 3 |
| Example 12 | COC-2 | 146 | 0.2 | 0.5 | 3 | 10 | 3 |
| Example 13 | COC-2 | 146 | 0.2 | 0.5 | 3 | 10 | 3 |
| Example 14 | COC-2 | 146 | 0.2 | 0.5 | 3 | 10 | 3 |
| Example 15 | COC-2 | 146 | 0.2 | 0.5 | 3 | 10 | 3 |
| Comparative | COC-2 | 146 | 0.2 | 0.5 | 3 | 10 | 3 |
| Example 6 | | | | | | | |
| Comparative | PSf | 180 | 0.3 | 0 | 2.6 | 9 | 6 |
| Example 7 | | | | | | | |
| Example 16 | PSf | 180 | 0.3 | 0.1 | 2.6 | 9 | 6 |
| Example 17 | PSf | 180 | 0.3 | 0.3 | 2.6 | 9 | 6 |
| Example 18 | PSf | 180 | 0.3 | 3 | 2.6 | 9 | 6 |
| Example 19 | PSf | 180 | 0.3 | 8 | 2.6 | 9 | 6 |
| Example 20 | PSf | 180 | 0.3 | 10 | 2.6 | 9 | 6 |
| Comparative | PSf | 180 | 0.3 | 11 | 2.6 | 9 | 6 |
| Example 8 | | | | | | | |
| Comparative | COC-3 | 169 | 0.01 | 1 | 2.2 | 8 | 0 |
| Example 9 | | | | | | | |
| Example 21 | COC-3 | 169 | 0.01 | 1 | 2.2 | 8 | 1 |
| Example 22 | COC-3 | 169 | 0.01 | 1 | 2.2 | 8 | 2 |
| Example 23 | COC-3 | 169 | 0.01 | 1 | 2.2 | 8 | 11 |
| Example 24 | COC-3 | 169 | 0.01 | 1 | 2.2 | 8 | 25 |
| Example 25 | COC-3 | 169 | 0.01 | 1 | 2.2 | 8 | 30 |
| Comparative | COC-3 | 169 | 0.01 | 1 | 2.2 | 8 | 35 |
| Example 10 | | | | | | | |
| Example 26 | TOPAS 6015 | 154 | 0.01 | 2 | 1.8 | 7 | 9 |
| Example 27 | TOPAS 6015 | 154 | 0.01 | 2 | 1.8 | 7 | 9 |
| Example 28 | TOPAS 6015 | 154 | 0.01 | 2 | 1.8 | 7 | 9 |
| Example 29 | TOPAS 6015 | 154 | 0.01 | 2 | 1.8 | 7 | 9 |
| Example 30 | TOPAS 6015 | 154 | 0.01 | 2 | 1.8 | 7 | 9 |
| Example 31 | TOPAS 6015 | 154 | 0.01 | 2 | 1.8 | 7 | 9 |
| Example 32 | TOPAS 6015 | 154 | 0.01 | 2 | 1.8 | 7 | 9 |

| | | Cooling | |
|---|---|---|---|
| | | Temperature difference on front | |
| | | and back surfaces of the film at | Tension fluctuation at |
| | Film forming | Tg −20° C. to Tg −40° C. | Tg −20° C. to Tg −40° C. |
| | Vc/Vd | ° C. | % |
| Example 1 | 11 | 1.2 | 1 |
| Example 2 | 11 | 1.2 | 1 |
| Example 3 | 11 | 1.2 | 1 |
| Example 4 | 11 | 1.2 | 1 |
| Example 5 | 11 | 1.2 | 1 |
| Example 6 | 11 | 1.2 | 1 |
| Example 7 | 11 | 1.2 | 1 |
| Comparative | 11 | 1.2 | 1 |
| Example 1 | | | |
| Comparative | 11 | 1.2 | 1 |
| Example 2 | | | |
| Comparative | 11 | 1.2 | 1 |
| Example 3 | | | |
| Comparative | 11 | 1.2 | 1 |
| Example 4 | | | |
| Example 8 | 11 | 1.2 | 1 |
| Example 9 | 11 | 1.2 | 1 |
| Example 10 | 11 | 1.2 | 1 |
| Comparative | 1 | 1 | 0.3 |
| Example 5 | | | |
| Example 11 | 2 | 1 | 0.3 |
| Example 12 | 3 | 1 | 0.3 |
| Example 13 | 9 | 1 | 0.3 |
| Example 14 | 20 | 1 | 0.3 |
| Example 15 | 30 | 1 | 0.3 |
| Comparative | 35 | 1 | 0.3 |
| Example 6 | | | |
| Comparative | 4 | 1 | 0.6 |
| Example 7 | | | |
| Example 16 | 4 | 1 | 0.6 |
| Example 17 | 4 | 1 | 0.6 |
| Example 18 | 4 | 1 | 0.6 |
| Example 19 | 4 | 1 | 0.6 |
| Example 20 | 4 | 1 | 0.6 |
| Comparative | 4 | 1 | 0.6 |
| Example 8 | | | |
| Comparative | 6 | 1 | 0.8 |
| Example 9 | | | |
| Example 21 | 6 | 1 | 0.8 |
| Example 22 | 6 | 1 | 0.8 |
| Example 23 | 6 | 1 | 0.8 |
| Example 24 | 6 | 1 | 0.8 |
| Example 25 | 6 | 1 | 0.8 |
| Comparative | 6 | 1 | 0.8 |
| Example 10 | | | |
| Example 26 | 7 | 0 | 1 |
| Example 27 | 7 | 0.1 | 1 |
| Example 28 | 7 | 0.2 | 1 |
| Example 29 | 7 | 1 | 1 |
| Example 30 | 7 | 5 | 1 |
| Example 31 | 7 | 10 | 1 |
| Example 32 | 7 | 11 | 1 |

TABLE 4

| | | Film forming | | | | | |
|---|---|---|---|---|---|---|---|
| | | | | Discharge | | Die temperature | Lip gap |
| | Resin | | | fluctuation | Step(s) in die | distribution | fluctuation |
| | Type | T ° C. | Y % | % | mm | ° C. | % |
| Example 33 | COC-2 | 146 | 0.01 | 3 | 1.4 | 7 | 12 |
| Example 34 | COC-2 | 146 | 0.01 | 3 | 1.4 | 7 | 12 |
| Example 35 | COC-2 | 146 | 0.01 | 3 | 1.4 | 7 | 12 |
| Example 36 | COC-2 | 146 | 0.01 | 3 | 1.4 | 7 | 12 |
| Example 37 | COC-2 | 146 | 0.01 | 3 | 1.4 | 7 | 12 |
| Example 38 | COC-2 | 146 | 0.01 | 3 | 1.4 | 7 | 12 |
| Example 39 | COC-2 | 146 | 0.01 | 3 | 1.4 | 7 | 12 |
| Example 40 | TOPAS 6017 | 173 | 0.01 | 4 | 0 | 7 | 14 |
| Example 41 | TOPAS 6017 | 173 | 0.01 | 4 | 0.1 | 7 | 14 |
| Example 42 | TOPAS 6017 | 173 | 0.01 | 4 | 0.2 | 7 | 14 |
| Example 43 | TOPAS 6017 | 173 | 0.01 | 4 | 1.5 | 7 | 14 |
| Example 44 | TOPAS 6017 | 173 | 0.01 | 4 | 5 | 7 | 14 |
| Example 45 | TOPAS 6017 | 173 | 0.01 | 4 | 6 | 7 | 14 |
| Example 46 | TOPAS 6015 | 154 | 0.01 | 5 | 1 | 7 | 16 |
| Example 47 | TOPAS 6015 | 154 | 0.01 | 5 | 1 | 7 | 16 |
| Example 48 | TOPAS 6015 | 154 | 0.01 | 5 | 1 | 7 | 16 |
| Example 49 | TOPAS 6015 | 154 | 0.01 | 5 | 1 | 7 | 16 |
| Example 50 | TOPAS 6015 | 154 | 0.01 | 5 | 1 | 7 | 16 |
| Example 51 | TOPAS 6015 | 154 | 0.01 | 5 | 1 | 7 | 16 |
| Example 52 | TOPAS 6015 | 154 | 0.01 | 5 | 1 | 7 | 16 |
| Example 53 | COC-2 | 146 | 0.01 | 6 | 0.6 | 7 | 18 |
| Example 54 | COC-2 | 146 | 0.01 | 6 | 0.6 | 7 | 18 |
| Example 55 | COC-2 | 146 | 0.01 | 6 | 0.6 | 7 | 18 |
| Example 56 | COC-2 | 146 | 0.01 | 6 | 0.6 | 7 | 18 |
| Example 57 | COC-2 | 146 | 0.01 | 6 | 0.6 | 7 | 18 |
| Example 58 | COC-2 | 146 | 0.01 | 6 | 0.6 | 7 | 18 |
| Example 59 | COC-2 | 146 | 0.01 | 6 | 0.6 | 7 | 18 |
| Example 60 | TOPAS 6015 | 154 | 0.01 | 7 | 0.3 | 7 | 20 |
| Example 61 | TOPAS 6015 | 154 | 0.01 | 7 | 0.3 | 7 | 20 |
| Example 62 | TOPAS 6015 | 154 | 0.01 | 7 | 0.3 | 7 | 20 |
| Comparative | *1 | 163 | 0.03 | 0 | 0 | 7 | 0 |
| Example 11 | | | | | | | |
| Example 63 | *1 | 163 | 0.03 | 3 | 1.5 | 5 | 10 |

| | | Cooling | |
|---|---|---|---|
| | | Temperature difference on front | |
| | | and back surfaces of the film at | Tension fluctuation at |
| | Film forming | Tg −20° C. to Tg −40° C. | Tg −20° C. to Tg −40° C. |
| | Vc/Vd | ° C. | % |
| Example 33 | 8 | 1 | 0 |
| Example 34 | 8 | 1 | 0.1 |
| Example 35 | 8 | 1 | 0.2 |
| Example 36 | 8 | 1 | 1 |
| Example 37 | 8 | 1 | 3 |
| Example 38 | 8 | 1 | 5 |
| Example 39 | 8 | 1 | 6 |
| Example 40 | 9 | 0.3 | 1.2 |
| Example 41 | 9 | 0.3 | 1.2 |
| Example 42 | 9 | 0.3 | 1.2 |
| Example 43 | 9 | 0.3 | 1.2 |
| Example 44 | 9 | 0.3 | 1.2 |
| Example 45 | 9 | 0.3 | 1.2 |
| Example 46 | 11 | 0.8 | 1.4 |
| Example 47 | 11 | 0.8 | 1.4 |
| Example 48 | 11 | 0.8 | 1.4 |
| Example 49 | 11 | 0.8 | 1.4 |
| Example 50 | 11 | 0.8 | 1.4 |
| Example 51 | 11 | 0.8 | 1.4 |
| Example 52 | 11 | 0.8 | 1.4 |
| Example 53 | 13 | 1.3 | 1.7 |
| Example 54 | 13 | 1.3 | 1.7 |
| Example 55 | 13 | 1.3 | 1.7 |
| Example 56 | 13 | 1.3 | 1.7 |
| Example 57 | 13 | 1.3 | 1.7 |
| Example 58 | 13 | 1.3 | 1.7 |
| Example 59 | 13 | 1.3 | 1.7 |
| Example 60 | 15 | 1.8 | 2 |
| Example 61 | 15 | 1.8 | 2 |
| Example 62 | 15 | 1.8 | 2 |
| Comparative | 1 | 0 | 0 |
| Example 11 | | | |
| Example 63 | 10 | 1 | 1 |

*1: Performed in conformity with Example 1 of JP2004-122433A

TABLE 5

| | | Stretching | | | |
|---|---|---|---|---|---|
| | | | | Temperature after | |
| | | | | stretching | Stretching speed |
| | | | | completion-starting | fluctuation |
| | | Vertical | Horizontal | temperature | (common to MD and TD) |
| | Type | magnification | magnification | ° C. | % |
| Example 101 | Film is formed in the same manner as in Example 2, | Unstretched | Unstretched | 8 | 1 |
| | but thickness = 30 μm | | | | |
| Example 102 | Film is formed in the same manner as in Example 2, | 1.1 | 1.1 | 8 | 1 |
| | but thickness = 36 μm | | | | |
| Example 103 | Film is formed in the same manner as in Example 2, | 1.5 | 1.5 | 8 | 1 |
| | but thickness = 67 μm | | | | |
| Example 104 | Film is formed in the same manner as in Example 2, | 2.5 | 2.5 | 8 | 1 |
| | but thickness = 206 μm | | | | |
| Example 105 | Film is formed in the same manner as in Example 2. | 4 | 4 | 8 | 1 |
| | but thickness = 480 μm | | | | |
| Example 106 | Film is formed in the same manner as in Example 2, | 5 | 5 | 8 | 1 |
| | but thickness = 750 μm | | | | |
| Example 107 | Film is formed in the same manner as in Example 2, | 5.2 | 5.2 | 8 | 1 |
| | but thickness = 810 μm | | | | |
| Example 108 | Film is formed in the same manner as in Example 1, | 2 | 2 | 1 | 2 |
| | but thickness = 160 μm | | | | |
| Example 109 | Film is formed in the same manner as in Example 1, | 2 | 2 | 2 | 2 |
| | but thickness = 160 μm | | | | |
| Example 110 | Film is formed in the same manner as in Example 1, | 2 | 2 | 10 | 2 |
| | but thickness = 160 μm | | | | |
| Example 111 | Film is formed in the same manner as in Example 1, | 2 | 2 | 25 | 2 |
| | but thickness = 160 μm | | | | |
| Example 112 | Film is formed in the same manner as in Example 1, | 2 | 2 | 30 | 2 |
| | but thickness = 160 μm | | | | |
| Example 113 | Film is formed in the same manner as in Example 3, | 1.5 | 1.5 | 14 | 0 |
| | but thickness = 112 μm | | | | |
| Example 114 | Film is formed in the same manner as in Example 3, | 1.5 | 1.5 | 14 | 0.1 |
| | but thickness = 112 μm | | | | |
| Example 115 | Film is formed in the same manner as in Example 3, | 1.5 | 1.5 | 14 | 0.2 |
| | but thickness = 112 μm | | | | |
| Example 116 | Film is formed in the same manner as in Example 3, | 1.5 | 1.5 | 14 | 2 |
| | but thickness = 112 μm | | | | |
| Example 117 | Film is formed in the same manner as in Example 3, | 1.5 | 1.5 | 14 | 5 |
| | but thickness = 112 μm | | | | |
| Example 118 | Film is formed in the same manner as in Example 3, | 1.5 | 1.5 | 14 | 10 |
| | but thickness = 112 μm | | | | |
| Example 119 | Film is formed in the same manner as in Example 3, | 1.5 | 1.5 | 14 | 12 |
| | but thickness = 112 μm | | | | |
| Comparative | Polymerization in conformity with Example 1 of | 2 | Unstretched | 0 | 0 |
| Example 12 | JP2011-43628A | | | | |
| Example 120 | Polymerization in conformity with Example 2 of | 2 | Unstretched | 10 | 1 |
| | JP2011-43628A | | | | |

TABLE 6

| | Physical properties | | | | | | |
|---|---|---|---|---|---|---|---|
| | | | | | | Inplane | |
| | | | | | | distribution | |
| | | | Inplane | | The number of | of the | |
| | | | distribution of | Distribution | times of | number of | Dimension |
| | | Rth | Rth | of dimension | folding | times of | shrinkage rate |
| | | (normalization | (normalization | rate at 125° C. | endurance | folding | at 125° C. 40% |
| | Thickness | at 100 μm) | at 100 μm) | 40% RH | The number of | endurance | RH |
| | μm | nm | % | % | times | % | % |
| Example 1 | 50 | 23 | 12 | 0.23 | 150 | 20 | 0.33 |
| Example 2 | 50 | 20 | 15 | 0.1 | 180 | 10 | 0.11 |
| Example 3 | 50 | 18 | 17 | 0.05 | 180 | 20 | 0.008 |
| Example 4 | 50 | 40 | 32 | 0.25 | 800 | 10 | 0.35 |
| Example 5 | 50 | 38 | 33 | 0.04 | 700 | 12 | 0.007 |
| Example 6 | 50 | 41 | 25 | 0.1 | 550 | 10 | 0.12 |
| Example 7 | 50 | 39 | 36 | 0.03 | 400 | 12 | 0.15 |
| Comparative | 50 | 32 | 31 | 0.35 | 80 | 21 | 0.7 |
| Example 1 | | | | | | | |
| Comparative | 50 | 17 | 15 | 0.44 | 70 | 23 | 0.78 |
| Example 2 | | | | | | | |
| Comparative | 50 | 48 | 45 | 0.32 | 3000 | 8 | 0.55 |
| Example 3 | | | | | | | |
| Comparative | 50 | 49 | 49 | 0.33 | 650 | 12 | 0.55 |
| Example 4 | | | | | | | |
| Example 8 | 50 | 22 | 13 | 0.2 | 165 | 20 | 0.28 |
| Example 9 | 50 | 21 | 14 | 0.13 | 170 | 20 | 0.22 |
| Example 10 | 50 | 19 | 16 | 0.04 | 175 | 15 | 0.1 |
| Comparative | 70 | 0 | 3 | 0.05 | 1000 | 20 | 0.75 |
| Example 5 | | | | | | | |
| Example 11 | 70 | 1 | 3 | 0.05 | 950 | 21 | 0.45 |
| Example 12 | 70 | 3 | 2.5 | 0.06 | 1050 | 19 | 0.35 |
| Example 13 | 70 | 15 | 3 | 0.06 | 1000 | 20 | 0.08 |
| Example 14 | 70 | 40 | 3.5 | 0.05 | 1000 | 19 | 0.4 |
| Example 15 | 70 | 50 | 3 | 0.06 | 950 | 21 | 0.5 |
| Comparative | 70 | 55 | 3 | 0.06 | 1050 | 20 | 0.77 |
| Example 6 | | | | | | | |
| Comparative | 20 | 5 | 0 | 0.07 | 900 | 18 | 0.82 |
| Example 7 | | | | | | | |
| Example 16 | 20 | 4.5 | 1 | 0.07 | 850 | 17 | 0.46 |
| Example 17 | 20 | 5.5 | 2 | 0.08 | 950 | 18 | 0.33 |
| Example 18 | 20 | 5 | 15 | 0.07 | 900 | 18 | 0.12 |
| Example 19 | 20 | 4.5 | 40 | 0.08 | 850 | 17 | 0.38 |
| Example 20 | 20 | 5.5 | 50 | 0.07 | 950 | 18 | 0.46 |
| Comparative | 20 | 5 | 55 | 0.07 | 900 | 18 | 0.77 |
| Example 8 | | | | | | | |
| Comparative | 40 | 10 | 0 | 0.09 | 800 | 16 | 0.83 |
| Example 9 | | | | | | | |
| Example 21 | 40 | 9 | 1 | 0.08 | 750 | 15 | 0.47 |
| Example 22 | 40 | 10 | 2 | 0.09 | 800 | 16 | 0.32 |
| Example 23 | 40 | 9 | 15 | 0.08 | 750 | 16 | 0.1 |
| Example 24 | 40 | 10 | 40 | 0.09 | 800 | 15 | 0.36 |
| Example 25 | 40 | 9 | 50 | 0.08 | 750 | 16 | 0.47 |
| Comparative | 40 | 9 | 55 | 0.09 | 800 | 15 | 0.79 |
| Example 10 | | | | | | | |
| Example 26 | 50 | 15 | 10 | 0.11 | 700 | 14 | 0 |
| Example 27 | 50 | 14 | 9 | 0.1 | 650 | 13 | 0.005 |
| Example 28 | 50 | 15 | 10 | 0.11 | 700 | 14 | 0.008 |
| Example 29 | 50 | 14 | 9 | 0.1 | 650 | 14 | 0.12 |
| Example 30 | 50 | 15 | 10 | 0.11 | 700 | 13 | 0.4 |
| Example 31 | 50 | 14 | 10 | 0.11 | 700 | 14 | 0.5 |
| Example 32 | 50 | 15 | 9 | 0.1 | 650 | 14 | 0.55 |

| | | | | Transparent conductive film | | | |
|---|---|---|---|---|---|---|---|
| | | | | | | Increase | |
| | | | | | | ratio of | |
| | | | | | | electric | |
| | Physical properties | | | | | resistance | |
| | Total light | | Foreign | | Width of | after thermo | |
| | transmittance | Shredded | substances | | wire | treatment | Visibility of |
| | % | waste | /m² | Type | μm | % | wiring |
| Example 1 | 92 | 1 | 0 | AgX | 5 | 7 | 0 |
| Example 2 | 92 | 1 | 0 | AgX | 5 | 0 | 0 |
| Example 3 | 92 | 1 | 0 | AgX | 5 | 2 | 0 |
| Example 4 | 91 | 0 | 0 | AgX | 5 | 6 | 0 |
| Example 5 | 83 | 0 | 0 | AgX | 5 | 2 | 0 |
| Example 6 | 87 | 0 | 0 | AgX | 5 | 0 | 0 |
| Example 7 | 82 | 0 | 0 | AgX | 5 | 0 | 0 |
| Comparative | 91 | 13 | 0 | AgX | 5 | 45 | 0 |
| Example 1 | | | | | | | |
| Comparative | 92 | 15 | 0 | AgX | 5 | 55 | 0 |
| Example 2 | | | | | | | |
| Comparative | 90 | 3 | 0 | AgX | 5 | 40 | 0 |
| Example 3 | | | | | | | |
| Comparative | 92 | 0 | 0 | AgX | 5 | 50 | 0 |
| Example 4 | | | | | | | |
| Example 8 | 92 | 1 | 0 | AgX | 5 | 5 | 0 |
| Example 9 | 92 | 1 | 0 | AgX | 5 | 0 | 0 |
| Example 10 | 92 | 1 | 0 | AgX | 5 | 0 | 0 |
| Comparative | 91 | 0 | 0 | AgX | 3 | 25 | 0 |
| Example 5 | | | | | | | |
| Example 11 | 91 | 0 | 0 | AgX | 3 | 9 | 0 |
| Example 12 | 92 | 0 | 0 | AgX | 3 | 4 | 0 |
| Example 13 | 91 | 0 | 0 | AgX | 3 | 0 | 0 |
| Example 14 | 91 | 0 | 0 | AgX | 3 | 3 | 0 |
| Example 15 | 92 | 0 | 0 | AgX | 3 | 8 | 0 |
| Comparative | 91 | 0 | 0 | AgX | 3 | 24 | 0 |
| Example 6 | | | | | | | |
| Comparative | 83 | 0 | 0 | AgX | 4 | 29 | 0 |
| Example 7 | | | | | | | |
| Example 16 | 82 | 0 | 0 | AgX | 4 | 8 | 0 |
| Example 17 | 83 | 0 | 0 | AgX | 4 | 5 | 0 |
| Example 18 | 83 | 0 | 0 | AgX | 4 | 1 | 0 |
| Example 19 | 82 | 0 | 0 | AgX | 4 | 4 | 0 |
| Example 20 | 83 | 0 | 0 | AgX | 4 | 9 | 0 |
| Comparative | 82 | 0 | 0 | AgX | 4 | 27 | 0 |
| Example 8 | | | | | | | |
| Comparative | 92 | 0 | 0 | AgX | 5 | 29 | 0 |
| Example 9 | | | | | | | |
| Example 21 | 92 | 0 | 0 | AgX | 5 | 7 | 0 |
| Example 22 | 93 | 0 | 0 | AgX | 5 | 4 | 0 |
| Example 23 | 92 | 0 | 0 | AgX | 5 | 0 | 0 |
| Example 24 | 92 | 0 | 0 | AgX | 5 | 3 | 0 |
| Example 25 | 93 | 0 | 0 | AgX | 5 | 8 | 0 |
| Comparative | 92 | 0 | 0 | AgX | 5 | 26 | 0 |
| Example 10 | | | | | | | |
| Example 26 | 93 | 0 | 0 | AgX | 1 | 15 | 0 |
| Example 27 | 92 | 0 | 0 | AgX | 1 | 5 | 0 |
| Example 28 | 92 | 0 | 0 | AgX | 1 | 2 | 0 |
| Example 29 | 93 | 0 | 0 | AgX | 1 | 0 | 0 |
| Example 30 | 92 | 0 | 0 | AgX | 1 | 3 | 0 |
| Example 31 | 92 | 0 | 0 | AgX | 1 | 6 | 0 |
| Example 32 | 93 | 0 | 0 | AgX | 1 | 16 | 0 |

TABLE 7

| | Physical properties | | | | | | |
|---|---|---|---|---|---|---|---|
| | | | | | | Inplane | |
| | | | | | | distribution | |
| | | | Inplane | | The number of | of the | |
| | | | distribution of | Distribution | times of | number of | Dimension |
| | | Rth | Rth | of dimension | folding | times of | shrinkage rate |
| | | (normalization | (normalization | rate at 125° C. | endurance | folding | at 125° C. 40% |
| | Thickness | at 100 μm) | at 100 μm) | 40% RH | The number of | endurance | RH |
| | μm | nm | % | % | times | % | % |
| Example 33 | 60 | 19 | 14 | 0 | 600 | 12 | 0.12 |
| Example 34 | 60 | 18 | 15 | 0.01 | 550 | 11 | 0.11 |
| Example 35 | 60 | 19 | 14 | 0.03 | 600 | 12 | 0.12 |
| Example 36 | 60 | 18 | 14 | 0.1 | 600 | 12 | 0.12 |
| Example 37 | 60 | 19 | 15 | 0.25 | 550 | 11 | 0.12 |
| Example 38 | 60 | 19 | 14 | 0.3 | 600 | 12 | 0.11 |
| Example 39 | 60 | 18 | 14 | 0.35 | 550 | 12 | 0.12 |
| Example 40 | 30 | 23 | 18 | 0.13 | 40 | 10 | 0.03 |
| Example 41 | 30 | 22 | 17 | 0.12 | 50 | 9 | 0.03 |
| Example 42 | 30 | 23 | 18 | 0.13 | 80 | 10 | 0.02 |
| Example 43 | 30 | 22 | 18 | 0.13 | 500 | 10 | 0.03 |
| Example 44 | 30 | 23 | 17 | 0.13 | 2000 | 9 | 0.02 |
| Example 45 | 30 | 22 | 18 | 0.12 | 2500 | 10 | 0.03 |
| Example 46 | 50 | 27 | 22 | 0.15 | 500 | 2 | 0.1 |
| Example 47 | 50 | 26 | 23 | 0.14 | 450 | 3 | 0.1 |
| Example 48 | 50 | 27 | 22 | 0.15 | 500 | 5 | 0.09 |
| Example 49 | 50 | 27 | 23 | 0.14 | 500 | 12 | 0.1 |
| Example 50 | 50 | 26 | 22 | 0.14 | 450 | 25 | 0.11 |
| Example 51 | 50 | 27 | 22 | 0.15 | 500 | 30 | 0.1 |
| Example 52 | 50 | 26 | 23 | 0.14 | 450 | 35 | 0.1 |
| Example 53 | 60 | 31 | 26 | 0.17 | 400 | 8 | 0.15 |
| Example 54 | 60 | 31 | 26 | 0.17 | 400 | 8 | 0.15 |
| Example 55 | 60 | 31 | 26 | 0.17 | 400 | 8 | 0.15 |
| Example 56 | 60 | 31 | 26 | 0.17 | 400 | 8 | 0.15 |
| Example 57 | 60 | 31 | 26 | 0.17 | 400 | 8 | 0.15 |
| Example 58 | 60 | 31 | 26 | 0.17 | 400 | 8 | 0.15 |
| Example 59 | 60 | 31 | 26 | 0.17 | 400 | 8 | 0.15 |
| Example 60 | 70 | 35 | 30 | 0.2 | 300 | 7 | 0.24 |
| Example 61 | 70 | 35 | 30 | 0.2 | 300 | 7 | 0.24 |
| Example 62 | 70 | 35 | 30 | 0.2 | 300 | 7 | 0.24 |
| Comparative | 50 | 0 | 0 | 0 | 40 | 0 | 0.13 |
| Example 11 | | | | | | | |
| Example 63 | 50 | 15 | 12 | 0.11 | 120 | 12 | 0.12 |

| | | | | Transparent conductive film | | | |
|---|---|---|---|---|---|---|---|
| | | | | | | Increase | |
| | | | | | | ratio of | |
| | | | | | | electric | |
| | Physical properties | | | | | resistance | |
| | Total light | | Foreign | | Width of | after thermo | |
| | transmittance | Shredded | substances | | wire | treatment | Visibility of |
| | % | waste | /m² | Type | μm | % | wiring |
| Example 33 | 92 | 0 | 0 | AgX | 14 | 17 | 0 |
| Example 34 | 93 | 0 | 0 | AgX | 14 | 6 | 0 |
| Example 35 | 93 | 0 | 0 | AgX | 14 | 3 | 0 |
| Example 36 | 92 | 0 | 0 | AgX | 14 | 0 | 0 |
| Example 37 | 92 | 0 | 0 | AgX | 14 | 2 | 0 |
| Example 38 | 93 | 0 | 0 | AgX | 14 | 7 | 0 |
| Example 39 | 92 | 0 | 0 | AgX | 14 | 15 | 0 |
| Example 40 | 92 | 0 | 0 | AgX | 6 | 18 | 0 |
| Example 41 | 93 | 0 | 0 | AgX | 6 | 8 | 0 |
| Example 42 | 92 | 0 | 0 | AgX | 6 | 4 | 0 |
| Example 43 | 92 | 0 | 0 | AgX | 6 | 1 | 0 |
| Example 44 | 93 | 0 | 10 | AgX | 6 | 1 | 0 |
| Example 45 | 92 | 0 | 150 | AgX | 6 | 1 | 0 |
| Example 46 | 92 | 45 | 0 | AgX | 2 | 0 | 0 |
| Example 47 | 93 | 15 | 0 | AgX | 2 | 0 | 0 |
| Example 48 | 92 | 3 | 0 | AgX | 2 | 0 | 0 |
| Example 49 | 93 | 0 | 0 | AgX | 2 | 0 | 0 |
| Example 50 | 92 | 4 | 0 | AgX | 2 | 0 | 0 |
| Example 51 | 92 | 14 | 0 | AgX | 2 | 0 | 0 |
| Example 52 | 93 | 51 | 0 | AgX | 2 | 0 | 0 |
| Example 53 | 92 | 0 | 0 | AgX | 0.05 | 12 | 0 |
| Example 54 | 93 | 0 | 0 | AgX | 0.1 | 4 | 0 |
| Example 55 | 92 | 0 | 0 | AgX | 0.3 | 0 | 0 |
| Example 56 | 93 | 0 | 0 | AgX | 3 | 0 | 0 |
| Example 57 | 92 | 0 | 0 | AgX | 30 | 0 | 1 |
| Example 58 | 93 | 0 | 0 | AgX | 50 | 0 | 3 |
| Example 59 | 92 | 0 | 0 | AgX | 60 | 0 | 4 |
| Example 60 | 93 | 0 | 0 | AgX | 3 | 0 | 0 |
| Example 61 | 92 | 0 | 0 | Ag fiber | 3 | 3 | 0 |
| Example 62 | 93 | 0 | 0 | ITO | 3 | 12 | 0 |
| Comparative | 92 | 48 | 8 | AgX | 4 | 29 | 0 |
| Example 11 | | | | | | | |
| Example 63 | 92 | 0 | 0 | AgX | 4 | 0 | 0 |

TABLE 8

| | Physical properties | | | | | | |
|---|---|---|---|---|---|---|---|
| | | | | | | | Inplane |
| | | | Inplane | | | The number | distribution of |
| | | | distribution of | Dimension | Distribution of | of times of | the number of |
| | | Rth | Rth | shrinkage | dimension rate | folding | times of |
| | | (normalization | (normalization | rate at 125° C. | at 125° C. 40% | endurance | folding |
| | Thickness | at 100 μm) | at 100 μm) | 40% RH | RH | The number | endurance |
| | μm | nm | % | % | % | of times | % |
| Example 101 | 30 | 12 | 12 | 0.11 | 0.1 | 40 | 10 |
| Example 102 | 30 | 16 | 14 | 0.15 | 0.12 | 70 | 12 |
| Example 103 | 30 | 23 | 13 | 0.19 | 0.11 | 90 | 12 |
| Example 104 | 30 | 32 | 12 | 0.22 | 0.12 | 200 | 11 |
| Example 105 | 30 | 40 | 13 | 0.28 | 0.11 | 80 | 10 |
| Example 106 | 30 | 46 | 14 | 0.38 | 0.12 | 60 | 11 |
| Example 107 | 30 | 48 | 12 | 0.42 | 0.11 | 40 | 10 |
| Example 108 | 40 | 50 | 11 | 0.5 | 0.28 | 200 | 23 |
| Example 109 | 40 | 40 | 12 | 0.4 | 0.29 | 210 | 22 |
| Example 110 | 40 | 20 | 12 | 0.1 | 0.29 | 200 | 23 |
| Example 111 | 40 | 4 | 11 | 0.35 | 0.28 | 90 | 22 |
| Example 112 | 40 | 2 | 12 | 0.45 | 0.29 | 70 | 23 |
| Example 113 | 50 | 24 | 19 | 0.012 | 0.06 | 210 | 2 |
| Example 114 | 50 | 25 | 18 | 0.013 | 0.07 | 200 | 3 |
| Example 115 | 50 | 24 | 19 | 0.012 | 0.06 | 210 | 5 |
| Example 116 | 50 | 24 | 19 | 0.012 | 0.07 | 200 | 10 |
| Example 117 | 50 | 25 | 18 | 0.013 | 0.06 | 210 | 25 |
| Example 118 | 50 | 24 | 19 | 0.012 | 0.07 | 200 | 30 |
| Example 119 | 50 | 24 | 19 | 0.013 | 0.06 | 210 | 35 |
| Comparative | 86 | 160 | 0 | 0.59 | 0.1 | 190 | 1 |
| Example 12 | | | | | | | |
| Example 120 | 86 | 25 | 15 | 0.01 | 0.1 | 200 | 12 |

| | | | | Transparent conductive film | | | |
|---|---|---|---|---|---|---|---|
| | | | | | | Increase | |
| | | | | | | ratio of | |
| | | | | | | electric | |
| | Physical properties | | | | | resistance | |
| | Total light | | Foreign | | Width of | after thermo | |
| | transmittance | Shredded | substances | | wire | treatment | Visibility of |
| | % | waste | /m² | Type | μm | % | wiring |
| Example 101 | 92 | 0 | 0 | AgX | 4 | 17 | 0 |
| Example 102 | 92 | 0 | 0 | AgX | 4 | 8 | 0 |
| Example 103 | 93 | 0 | 0 | AgX | 4 | 5 | 0 |
| Example 104 | 92 | 0 | 0 | AgX | 4 | 0 | 0 |
| Example 105 | 92 | 0 | 0 | AgX | 4 | 4 | 0 |
| Example 106 | 92 | 0 | 0 | AgX | 4 | 7 | 0 |
| Example 107 | 93 | 0 | 0 | AgX | 4 | 16 | 0 |
| Example 108 | 93 | 0 | 0 | AgX | 3 | 7 | 0 |
| Example 109 | 92 | 0 | 0 | AgX | 3 | 4 | 0 |
| Example 110 | 92 | 0 | 0 | AgX | 3 | 0 | 0 |
| Example 111 | 93 | 0 | 0 | AgX | 3 | 3 | 0 |
| Example 112 | 92 | 0 | 0 | AgX | 3 | 10 | 0 |
| Example 113 | 93 | 52 | 0 | AgX | 6 | 2 | 0 |
| Example 114 | 92 | 14 | 0 | AgX | 6 | 1 | 0 |
| Example 115 | 93 | 6 | 0 | AgX | 6 | 0 | 0 |
| Example 116 | 92 | 0 | 0 | AgX | 6 | 0 | 0 |
| Example 117 | 92 | 7 | 0 | AgX | 6 | 0 | 0 |
| Example 118 | 93 | 15 | 0 | AgX | 6 | 1 | 0 |
| Example 119 | 92 | 56 | 0 | AgX | 6 | 2 | 0 |
| Comparative | 92 | 52 | 0 | AgX | 4 | 32 | 0 |
| Example 12 | | | | | | | |
| Example 120 | 93 | 0 | 0 | AgX | 4 | 0 | 0 |

From the results presented in the tables above, it is found that, since dimension shrinkage (rate of the dimensional change) was suppressed in the transparent film of the invention than in the comparative examples, the dimension shrinkage (the rate of the dimensional change) is suppressed even if a long period of time has passed under high humidity.

(Manufacturing of Touch Panel)

The touch panel was manufactured according to the disclosure of paragraphs “0073” to “0075” of JP2009-176608A using the transparent conductive film described above. Even if the film of the invention was stored for a long period of time under high humidity (at 35° C. 90% Rh for three years), the decrease of the performances is not generated and favorable performance was presented.

(Manufacturing of the Other Liquid Crystal Displaying Element)

The polarization plate using the example of the invention was used in the liquid crystal display device disclosed in Example 1 of JP1998-48420A (JP-H10-48420A), an optically anisotropic layer including discotic liquid crystal molecules and the oriented film coated with polyvinylalcohol disclosed in Example 1 of JP1997-26572A (JP-H09-26572A), and a 20 inch VA-type liquid crystal display device illustrated in FIGS. 2 to 9 of JP2000-154261A, and a 20 inch OCB-type liquid crystal display device illustrated in FIGS. 10 to 15 of JP2000-154261A, so as to obtain favorable characteristics.

### INDUSTRIAL APPLICABILITY

According to the invention, it is possible to obtain the transparent film and the transparent conductive film in which dimension shrinkage is suppressed, even if a long period of time has passed under high humidity. Therefore, the transparent film of the invention is appropriately used in a touch panel, an image display device, and the like, and thus has high industrial applicability.

What is claimed is:

1. A transparent film that satisfies Expressions (1) and (2),
wherein Rth that represents birefringence normalized in a thickness of 100 μm in a thickness direction is 1 nm to 50 nm,
wherein inplane distribution of the Rth is 1% to 50%,
130≦T≦200 Expression (1):
0≦Y<0.4 Expression (2):
wherein, in Expressions (1) and (2), T represents a glass transition temperature of the transparent film, and Y represents an equilibrium moisture content of the transparent film at 25° C., and
wherein a unit of the glass transition temperature is ° C., and a unit of the equilibrium moisture content is mass %.

2. The transparent film according to claim 1,
wherein distribution of dimension shrinkage of the transparent film at 125° C. 40% Rh is 0.01% to 0.3%.

3. The transparent film according to claim 1,
wherein the inplane distribution of the number of times of folding endurance is 3% to 30%.

4. The transparent film according to claim 1,
wherein the transparent film is manufactured by casting a resin on a casting drum by a die such that a ratio of a discharge speed Vd of a resin in a die outlet and a speed Vc of a casting drum becomes 2 to 30, and
wherein the ratio represents Vc/Vd.

5. A manufacturing method for the transparent film according to claim 1, comprising:
casting a resin to a casting drum by a die, such that a ratio of a discharge speed Vd of the resin in a die outlet and a speed Vc of the casting drum becomes 2 to 30,
wherein the ratio represents Vc/Vd.

6. The manufacturing method according to claim 5, further comprising:
providing a fluctuation of 1% to 30% in a width direction at a lip gap which is an interval of a die lip of a die outlet.

7. The manufacturing method according to claim 5, further comprising:
providing a discharge fluctuation which is a time fluctuation to an amount of a resin supplied to the die by 0.1% to 10%.

8. The manufacturing method according to claim 5, further comprising:
providing a temperature difference of 0.1° C. to 10° C. on front and back surfaces of the film during cooling from a point lower than the glass transition temperature by 20° C. to a point lower than the glass transition temperature by 40° C. in cooling the film after the film forming to room temperature.

9. The manufacturing method according to claim 5, further comprising:
providing a fluctuation of 0.1% to 5% to transport tension of the film during cooling from a point lower than the glass transition temperature by 20° C. to a point lower than the glass transition temperature by 40° C. in cooling the film after the film forming to room temperature.

10. The manufacturing method according to claim 5, further comprising:
providing a step of 0.1 mm to 5 mm in a die in forming the film by discharging a resin from the die.

11. The manufacturing method according to claim 5, further comprising:
providing a temperature difference of 0.5° C. to 20° C. in a die in forming the film by discharging a resin from the die.

12. The manufacturing method according to claim 5, further comprising:
stretching a film manufactured by performing casting, in a stretching ratio of 1.1 times to 5 times in at least one axis direction.

13. A transparent conductive film, comprising:
the transparent film according to claim 1; and
a conductive layer.

14. The transparent conductive film according to claim 13,
wherein the conductive layer is formed with a thin wire having a width of 0.1 μm to 50 μm.

15. The transparent conductive film according to claim 14,
wherein the thin wire includes Ag.

16. The transparent conductive film according to claim 15,
wherein the thin wire including Ag is formed by developing silver halide.

17. A touch panel having the transparent film according to claim 1.

18. An anti-reflection film having the transparent film according to claim 1.

19. A polarization plate having the transparent film according to claim 1.

20. A display device having the transparent film according to claim 1.
